(19) United States
(12) Patent Application Publication
(10) Pub. No.: US 2025/0273094 A1
(43) Pub. Date: Aug. 28, 2025

(54) LIGHT BLOCKING LABELS

(71) Applicant: Multi-Color Corporation, Batavia, OH (US)

(72) Inventors: John Franklin Henderson, Cumming, GA (US); Oliver Crowhurst, Schwenksville, PA (US); Thomas Gordon Scully, Sellersburg, IN (US); Noel Glenn Stewart, Cumming, GA (US); Hartmut L. Swisher, Pittsford, NY (US)

(21) Appl. No.: 19/061,153

(22) Filed: Feb. 24, 2025

Related U.S. Application Data
(60) Provisional application No. 63/557,400, filed on Feb. 23, 2024.

(51) Int. Cl. G09F 3/02; B32B 27/08; B32B 27/36; B41M 1/10; B41M 3/00; G09F 3/10

(52) U.S. Cl. CPC G09F 3/02; B32B 27/08; B32B 27/36; B41M 1/10; B41M 3/008; G09F 3/10; B32B 2250/02; B32B 2250/244; B32B 2255/10; B32B 2255/28; B32B 2307/4023; B32B 2307/41; B32B 2519/00; G09F 2003/0201; G09F 2003/0223; G09F 2003/0242; G09F 2003/0257

(57) ABSTRACT

A light-blocking label configured to be affixed to an article made of a polymeric material such as polyethylene terephthalate (PET), high density polyethylene (HDPE), other similar polymeric materials, or some combination thereof. The light-blocking label includes a light-blocking ink layer that may be reverse printed onto the label substrate while other ink layers (e.g., white ink layer, color ink layer) may be surface printed on the label substrate. The light-blocking label may also include an optional varnish and/or adhesive layer. In some embodiments, the label substrate and article comprise PET and are configured to be collected as recycled PET (i.e., a recyclable light blocking label). In such an embodiment, the one or more ink layers and optional layers in the light-blocking may be configured to be removed prior to collection of the light-blocking label as recycled PET.

### FIELD OF THE INVENTION

The present invention generally relates to labels, and more particularly to labels that provide enhanced light blocking properties. In some embodiments, these labels are configured to provide enhanced light blocking properties without sacrificing recyclability and/or enhanced recycling compatibility.

### CROSS-REFERENCE TO RELATED APPLICATIONS

This application claims the filing benefit of U.S. Provisional Application No. 63/557,400 filed on Feb. 23, 2024, the disclosure of which is incorporated herein by reference in its entirety.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

The concept of affixing a label to an article is old and well known. Certain labels typically may include a label substrate and one or more inks and adhesives. The labels typically include decoration (such as visible graphics, text, and/or other indicia). Types of articles that labels are affixed include articles made of high density polyethylene (HDPE) and polyethylene terephthalate (PET). Various kinds of articles made of HDPE and/or PET to which such labels may be affixed include, but are not limited to, drinking bottles, microwaveable trays, and food containers. It is also well known that labels having light-blocking properties can be beneficial in certain contexts. For example, exposure to light may cause or increase spoilage of a product contained within the article. Some products that may benefit from a light-blocking label include, for example, dairy products, bottled beverages, cooking oils, spices, coffee, chocolate, and medications.

With respect to light-blocking labels in general, there is a need to maintain the appearance of the label indicia or graphic without sacrificing the light-blocking properties. To this end, conventional light-blocking labels used for articles made of HDPE and/or PET typically reduce the “whiteness” of a label as measured using the L-value, adversely affecting the appearance of any visible graphics, text, and/or other indicia applied to the label. This reduces the value of conventional light-blocking labels in common situations, such as where brand owners must choose between adequate light blocking properties and clarity of visible graphics, text, and/or other indicia applied to the label.

One problem that arises with affixing labels to articles made of PET is that, when companies attempt to recycle the article, the label is often still affixed to the article. And so, the label must be separated from the article prior to moving the article into a recycled materials stream (or as an initial step in such a recycled materials stream). In keeping with the examples discussed above, articles configured to be recycled may be made of PET. Examples of label materials that are conventionally removed from articles made of PET prior to collection of recycled PET include, but are not limited to, polypropylene (PP), biaxially oriented polypropylene (BOPP), polyvinyl chloride (PVC), glycol modified PET (PETG), Oriented Polystyrene (OPS), paper, or some combination thereof. Conventional methods of removing a label from articles made of PET include, but are not limited to, subjecting the labelled article to a caustic bath or to grinding.

In some recycling systems, materials that cannot be collected as recycled PET, such as the labels described above, are removed and separated from the article made of PET based on a difference in specific gravity. This removal and separation based on specific gravity may be implemented using a sink-float system, such as a conventional hot caustic bath sink-float system. In such a system, materials with a specific gravity less than 1.0, such as the polypropylene conventional labels described above, float to the top of a caustic bath, while materials with a specific gravity greater than 1.0, such as PET, sink to the bottom of the caustic bath. Once the dense materials sink to the bottom of the caustic bath, the materials may be shredded into small pieces (flakes) and subsequently collected as recycled PET. In some hot caustic bath sink-float systems, the article is shredded before the label is removed. The light materials that float to the top are skimmed off of the surface and collected to determine whether recycling of those skimmed materials is reasonably possible. If several different types of materials float to the top of the hot caustic bath, then the resulting mixture of materials must be separated into individual components before recycling is possible. In many such circumstances, the effort required to separate out these mixtures makes it undesirable to even attempt recycling the mixture.

If, on the other hand, the label materials happen to have a specific gravity greater than 1.0, certain challenges arise. One such challenge is that the label materials can cause contamination to the PET recyclate when they sink to the bottom of the caustic bath along with the PET article. This is especially a concern for labels including OPS, PVC and PETG. In addition, the ink components attached to those dense label materials can further impact recyclate quality.

In the past, there have been PET labels with light-blocking properties which, generally speaking, function to block light by either using a label substrate that is opaque or by applying an ink onto the label to increase the opacity. However, these conventional methods of blocking light often reduce or prevent the recyclability of the label. For example, one conventional method for imparting light-blocking properties onto a label is to use PETG as an opaque label substrate. However, the inclusion of PETG in the recycle stream faces the same issues with PET recyclate contamination described above. Another way that light-blocking properties of a label can be increased is to apply an ink to a PET label (i.e., a pigmented PET label). However, conventional inks used to increase the label's opacity often end up becoming soluble in the caustic solution which can stain the ground PET flakes, thereby reducing its value and fitness for reuse, which can adversely impact the recyclability of the label and the article. In either case, the increased difficulty in recycling light-blocking labels results in reduced efficiency in the recycling process and decreased circularity of the labels.

### SUMMARY

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

One aspect of the present invention is a light-blocking label that includes a light-blocking ink layer reverse printed on a label substrate (i.e., configured to be proximal to the article when attached thereto) and one or more ink layer surface printed on the label substrate (i.e., configured to be distal from the article when attached thereto). As a result of reverse printing the light-blocking layer, the L-value of the one or more ink layer surface printed on the label may be increased relative to conventional light-blocking labels. In some embodiments, the light-blocking label may include a light-blocking ink layer including metallic pigment particles having an average size configured to further increase the L-value of the light-blocking label. In such embodiments, the article to which the light-blocking label is affixed may be or include PET, HDPE, other similar polymeric materials, or some combination thereof. Types of labels that may be used in accordance with this aspect of the invention include, but are not limited to, shrink-sleeve labels, wrap-around labels, in-mold labels, cut-and-stack labels, and pressure sensitive labels.

Another aspect of the present invention provides for a recyclable light-blocking label including a label substrate that is compatible with the article to which it is affixed in one or more recycling processes and a washable light-blocking ink that can be removed from the label in a magnetic separation step, a wash step, and/or a caustic bath step. The washable, light-blocking ink may be reverse printed on the label substrate (i.e., configured to be proximal to the article when attached thereto). The light-blocking label may also include one or more washable inks surface printed on the label substrate (i.e., configured to be distal from the article when attached thereto) that are configured to be removed therefrom in a wash step and/or a caustic bath step. As a result, the recyclable light-blocking label may be recycled in the same recycle stream as the article to which it is affixed. During processing and/or recycling, the washable light-blocking ink and/or the one or more washable inks may be configured to wash away from the light-blocking label without staining the recyclate by, for example, being removed by a magnetic drum and pulley sortation process or by becoming a particulate in the wash solution that can be removed from the recyclate using a removal process such as, for example, a filtration process, leaving at least the cleaned label substrate to proceed into the recycle stream with the article made of the same base material. One embodiment of the invention includes a light-blocking label that is configured to be affixed to an article made of PET such that the washable, light-blocking ink is proximal to the article made of PET when attached thereto, that overcomes the drawbacks to recyclability described above. Types of labels that may be used in accordance with this aspect of the invention include, but are not limited to, shrink-sleeve labels, wrap-around labels, in-mold labels, cut-and-stack labels, and pressure sensitive labels.

These and other advantages of the application will be apparent to those of skill in the art with reference to the drawings and the detailed description below.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention. Similar reference numerals are used to indicate similar features throughout the various figures of the drawings.

FIG. 1 shows a cross-sectional view of one embodiment of a light-blocking label in accordance with an embodiment of the invention.

FIG. 2 shows a cross sectional view of another embodiment of a light-blocking label in accordance with an embodiment of the invention.

FIG. 3 shows a cross sectional view of another embodiment of a light-blocking label in accordance with an embodiment of the invention.

FIG. 4 shows a cross sectional view of another embodiment of a light-blocking label in accordance with an embodiment of the invention.

FIG. 5 shows a cross sectional view of another embodiment of a light-blocking label in accordance with an embodiment of the invention.

FIG. 6 shows a cross sectional view of another embodiment of a light-blocking label in accordance with an embodiment of the invention.

FIG. 7 shows a cross sectional view of another embodiment of a light-blocking label in accordance with an embodiment of the invention.

FIG. 8 shows a cross sectional view of another embodiment of a light-blocking label in accordance with an embodiment of the invention.

FIG. 9 shows a cross sectional view of another embodiment of a light-blocking label in accordance with an embodiment of the invention.

FIG. 10 shows a cross sectional view of another embodiment of a light-blocking label in accordance with an embodiment of the invention.

FIG. 11 shows a cross sectional view of another embodiment of a light-blocking label in accordance with an embodiment of the invention.

FIG. 12 is a graph showing the relationship between transmittance and wavelength of light for six samples of light-blocking labels as further discussed in Example 1.

FIG. 13 is a graph showing the relationship between the number of bumps of white ink within the white ink layer surface printed on the label substrate and the L-value as well as the relationship between surface printing the light-blocking ink (Blocker Ink Direct) and reverse printing the light-blocking ink (Blocker Ink Reverse) on the L-value for six samples of light-blocking labels discussed in Example 2.

FIG. 14 is a table showing the different materials used in samples 1-8 compared in Example 4.

FIGS. 15A-H are graphs plotting the relationship between transmittance on the y-axis and wavelength of light on the x-axis for samples 1-8 respectively as discussed in further detail in Example 4.

### DETAILED DESCRIPTION OF EMBODIMENTS OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, one aspect of the present invention is a light-blocking label that includes a light-blocking ink layer reverse printed on a label substrate (i.e., configured to be proximal to the article when attached thereto) and one or more ink layer surface printed on the label substrate (i.e., configured to be distal from the article when attached thereto). As a result of reverse printing the light-blocking layer, the L-value of the one or more ink layer surface printed on the label may be increased relative to conventional light-blocking labels. In some embodiments, the light-blocking label may include a light-blocking ink layer including metallic pigment particles having an average size configured to further increase the L-value of the light-blocking label. In such embodiments, the article to which the light-blocking label is affixed may be or include PET, HDPE, other similar polymeric materials, or some combination thereof. Types of labels that may be used in accordance with this aspect of the invention include, but are not limited to, shrink-sleeve labels, wrap-around labels, in-mold labels, cut-and-stack labels, and pressure sensitive labels.

Another aspect of the present invention described above provides for a recyclable light-blocking label including a label substrate that is compatible with the article to which it is affixed in one or more recycling processes and a washable, light-blocking ink layer that can be removed from the label in a wash step or a caustic bath and that may be reverse printed on the label substrate (i.e., configured to be proximal to the article when attached thereto). The light-blocking label may also include one or more washable ink surface printed onto the label substrate (i.e., printed on the side opposite the washable light-blocking ink) that can be removed from the label in a wash step or a caustic bath by becoming a particulate in the wash solution, being able to be removed by the filtration process. As a result, the recyclable, light-blocking label may be recycled in the same recycle stream as the article to which it is affixed. During processing and/or recycling, the washable light-blocking ink and the one or more washable ink can be washed away, leaving at least the cleaned label substrate to proceed into the recycle stream with the article. One embodiment of the invention includes a light-blocking label that is be configured to be affixed to an article made of PET, that overcomes the drawbacks to recyclability described above. Types of labels that may be used in accordance with the invention include, but are not limited to, shrink-sleeve labels, wrap-around labels in-mold labels, as well as cut-and-stack labels and pressure sensitive labels.

The figures described below are shown in cross-sectional views. As shown, each of the light-blocking labels include multiple layers. When referring to these depictions, a layer depicted above another layer is configured to be more exterior than the other layer when the light-blocking label is affixed to the article (i.e., more distal from the article). Similarly, a layer depicted below another layer is configured to be more interior than the other layer when the light-blocking label is affixed to the article (i.e., more proximal to the article). When a layer is described relative to another layer, the term “between” is understood to mean “in the space separating at least those two other layers, but not necessarily in physical contact with either of those layers.” When a layer is described relative to another layer, the term “above” means “configured to be more exterior than at least that other layer, but not necessarily in physical contact with that other layer.” When a layer is described relative to another layer, the term “below” means “configured to be more interior than at least that other layer, but not necessarily in physical contact with that other layer.” When any of the terms “between,” “above,” or “below,” are modified by directly (e.g., directly between), then at least a portion of the layer must be in physical contact with at least a portion of the other layer(s). With respect to the label substrate (discussed further below), the position of the other layers relative to the label substrate layer may be indicative of how the layer was printed onto the label substrate or adjacent layer. For example, a layer positioned above the label substrate layer is generally understood to be “surface printed” while a layer positioned below the label substrate layer is generally understood to be “reverse printed” unless otherwise indicated.

While the layers in the light-blocking labels are shown to have equivalent or substantially similar sizes (lengths, depths, etc.), it should be understood that different layers may have different sizes. By way of example and not limitation, the label substrate 2 (discussed further below) may be sized to have a length that is configured to cover a perimeter of an article, such as an article made of PET, while an ink layer, such as the color ink layer 7 (discussed further below), may be sized such that it covers only a portion of the label substrate 2. Additionally, while the layers are shown to be continuous, it should be understood that one or more ink layer, such as the color ink layer 7 (discussed further below), may be implemented as a plurality of discontinuous portions of the light-blocking label. By way of example and not limitation, the optional adhesive layer 14 (discussed further below) may be applied to a plurality of discontinuous portions of the light blocking label.

With respect to the article (not shown) to which the light-blocking label is attached, the article may include one or more polymeric material such as PET, HDPE, other similar polymeric materials, or some combination thereof. In one embodiment, the light-blocking label is attached to an article made of HDPE. In another embodiment, the light-blocking label is attached to an article made of PET.

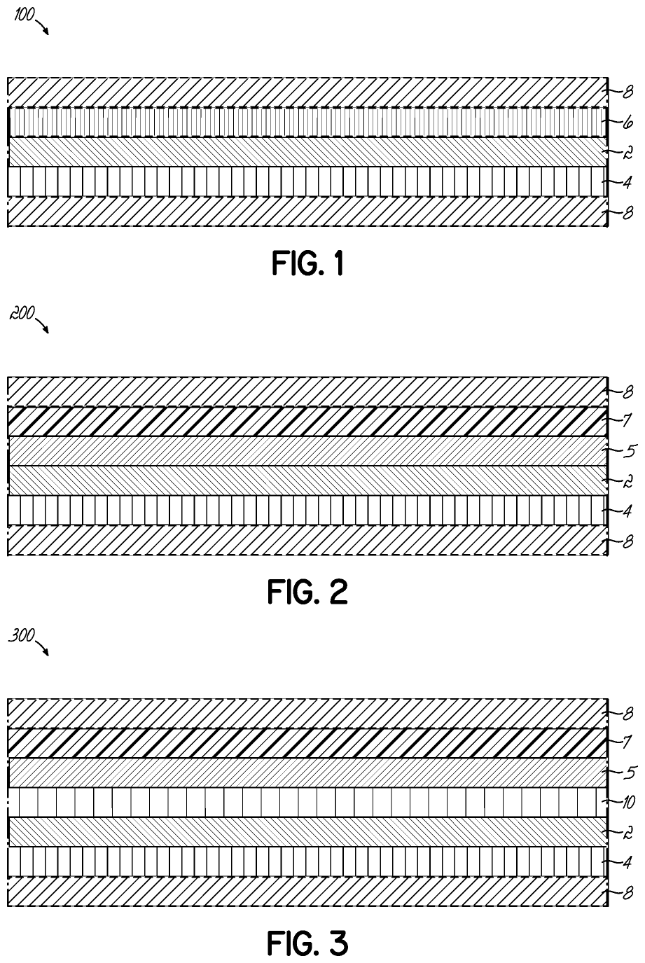

Referring now to FIG. 1, an embodiment of a light-blocking label 100 in accordance with the principles of the present invention is shown. As shown, the light-blocking label 100 includes a label substrate 2 that is positioned above a light-blocking ink layer 4 and below one or more optional ink layer 6. In this embodiment, a label substrate 2 is positioned between the light-blocking ink layer 4 and the optional ink layer 6. In a further embodiment, the label substrate 2 is positioned directly between both light-blocking ink layer 4 and the optional ink layer 6. The light-blocking label 100 may further include an optional varnish layer 8. The optional varnish layer 8 may be positioned above the optional ink layer 6, below the light-blocking ink layer 4, or both. In some further embodiments, the optional varnish layer 8 is positioned directly above the optional ink layer 6. In some further embodiments, the optional varnish layer 8 is positioned directly below the light-blocking ink layer 4. In embodiments where the light-blocking label 100 includes a label substrate 2 that is recyclable with the article to which it is attached and all other layers are configured to be removable therefrom in a wash step and/or caustic bath step, the light-blocking label 100 may be a recyclable light-blocking label 100.

In that regard, the label substrate 2 may be configured to be compatible with the article made of PET during recycling. For example, for articles made out of PET, the label substrate 2 may include PET, resins designed to be compatible with PET recycling, crystallized PET (CPET), recycled PET (i.e., PET that includes post-consumer recycled (PCR) material), or some combination thereof. In one embodiment, the label substrate 2 includes clear, virgin CPET. In another embodiment, the label substrate 2 includes clear, recycled CPET (i.e., CPET that includes PCR material). In one embodiment, the label substrate 2 includes biaxially oriented PET (BOPET). In another embodiment, the label substrate 2 includes transverse directionally oriented PET (TDO PET). In another embodiment, the label substrate 2 includes machine-direction oriented PET (MDO PET). One non-limiting example of a material for the label substrate 2 is the SCLRR 102435 45 μm gauge CPET film supplied by SKC Films.

The label substrate 2 may also be used in non-recyclable label constructions such as, for example, a label substrate 2 comprising polyethylene (PE), polypropylene (PP), or other materials not configured to be recycled together with a PET recyclate in a hot caustic bath recycling process. In one such embodiment, the label substrate 2 may further comprise PET. Examples of non-recyclable label constructions include floatable films (e.g., films having a density greater than 1 g/cc), white films, and other suitable label constructions not recoverable with a PET recyclate in a hot caustic bath recycling process.

The label substrate 2 has a gauge. In some embodiments, the label substrate 2 has a gauge greater than or equal to 10 μm and less than or equal to 100 μm. In some further embodiments, the label substrate 2 has a gauge greater than or equal to 19 μm and less than or equal to 55 μm. In some further embodiments, the label substrate 2 has a gauge greater than or equal to 12 μm and less than or equal to 30 μm. The gauge of the label substrate 2 may depend, at least in part, on the article on which the light-blocking label 100 is affixed.

The label substrate 2 may be configured to enable the light-blocking label 100 to function as a shrink sleeve label. In such embodiments, the label substrate 2 is configured to shrink when sufficient heat is applied. Alternatively, the label substrate 2 may be configured to enable the light-blocking label 100 to function as another type of label such as, for example, a wrap-around label, an in-mold label, a cut-and-stack label, a pressure-sensitive label, or some other label type known in the art. Some types of labels discussed above, such as the wrap-around label, may include additional layers not discussed above such as, for example, an adhesive layer (see discussion of optional adhesive layer 14 below).

The light-blocking ink layer 4 may be configured to be removed from the article made of PET (not shown) and the light-blocking label 100 during at least one of a wash step or a caustic bath recycling step. In such embodiments, the light-blocking ink layer 4 may be understood to be washable, light-blocking ink layer 4. In some embodiments, the washable, light-blocking ink layer 4 is configured to dissolve, disperse, or fragment when subjected to a caustic bath recycling step. In one such embodiment, the washable, light blocking ink layer 4 is designed to be removed as a particulate matter (i.e., ink fragments) during a caustic bath recycling step such that the ink fragments do not dissolve in or bleed into the caustic bath solution and can be readily filtered from wash and wastewater. In another such embodiment, the washable, light-blocking ink layer 4 is designed to be removed as particulate matter during a wash step prior to a caustic bath recycling step such that the ink fragments do not dissolve in the washing solution and can be readily filtered from wash and wastewater. To facilitate filtration, the ink fragments may have an average size in at least one dimension in the tens of microns. In other embodiments, the washable, light-blocking ink layer 4 is configured to dissolve or disperse or fragment during a wash step prior to any caustic bath recycling step. Preferably, the washable, light-blocking ink layer 4 is configured to be removed from the light-blocking label 100 in a manner such that it does not stain and is not redeposited on recycled PET (i.e., the recyclate) prior to collection.

Alternatively, in embodiments wherein the washable, light-blocking ink layer 4 includes a metallic flake pigment that is magnetizable (discussed further below), the washable, light-blocking ink layer 4 may be configured to be removed in a magnetic drum and pulley sortation step. In such a step, the metallic flake pigments themselves may be removed from the label or a wash/caustic solution using a magnetic drum to attract the magnetic, metallic flake pigment particles. These particles attracted to the magnetic drum can then be moved using the pulley system to another location where the magnetic field can be weakened sufficiently to release the magnetic, metallic flake pigment particles into, for example, a disposal container or chute.

The light-blocking ink layer 4 may be applied to the light-blocking label 100 using any conventional printing process, including but not limited to flexographic, rotary screen, lithography, digital, gravure, letterpress, and any combination of conventional printing methods. Such an embodiment may include a washable ink such as, but not limited to, a washable gravure ink or a washable flexographic ink. Non-limiting examples of the washable, light-blocking ink 4 used include the Genesis Light Blocking System gravure inks (e.g., the formulation for INX-1661572 supplied by INX International Ink Co.), the SunSpectro Solvawash GR and SunSpectro Solvawash FL ink systems (supplied by Sun Chemical), or the Nova™ gravure inks (e.g., the formulations for Novamet 2152, Novamet 2351, and Novamet 2355 (supplied by Multi-Color Corporation).

The light-blocking ink layer 4 may be configured to have a coefficient of friction (COF), a cohesive bond strength, and/or an anti-static property such that an adjacent optional varnish layer 8 is not necessary. In one embodiment, the light-blocking ink layer 4 may be configured to have a COF, a cohesive bond strength, and an anti-static property, the combination thereof rendering an adjacent optional varnish layer unnecessary. With regard to the COF, the light-blocking ink layer 4 may have a kinetic COF when measured ink-to-ink along the machine direction orientation between 0.07 and 0.60, alternatively between 0.10 and 0.30, or alternatively still between 0.15 and 0.25. Cohesive bond strength is related to the bond of the ink layer to itself (failure within the layer) as opposed to adhesive bond strength which refers to the bond of the ink to another layer. With regard to the cohesive bond strength, the light-blocking ink layer 4 may have a cohesive bond strength sufficient to prevent substantial ink removal (e.g., visual ink removal) when tested with number 600 3M brand adhesive tape using standard tape adhesion method (discussed further below).

The light-blocking ink layer 4 may include one or more colored ink. The light-blocking ink layer 4 may include a colored ink that is configured to reflect light, thereby improving the light-blocking properties of the label 100. In one such embodiment, the colored ink that is configured to reflect light included in the light-blocking ink layer 4 is or includes a metallic ink. The metallic ink may comprise one or more metallic flake pigment such as, for example, a silver flake pigment, an aluminum flake pigment, a platinum flake pigment, a palladium flake pigment, a stainless steel flake pigment, a galvanized steel flake pigment, an alloy flake pigment including one or more metal previously listed, or some combination thereof. It is considered that some metallic flake pigments or alloys above may be configured to be magnetizable such that they can be removed from the label substrate 2 and/or from a wash/caustic bath using a magnetic drum.

The average particle size and geometry of the metallic flake pigment may influence the light blocking characteristics and/or appearance of the light-blocking label 100. For example, the average particle size of the metallic flake pigment may affect the light-blocking characteristics and/or appearance of the light-blocking label 100 by influencing the color of the light-blocking ink layer 4 and/or the ink layer 6. In other embodiments of the light-blocking label including a white ink layer 5 and/or a color ink layer 7 (discussed further below), the average particle size of the metallic flake pigment may affect the appearance of the light-blocking ink layer 4, the white ink layer 5, and/or the color ink layer 7. The impact of the light-blocking ink layer 4 including a metallic ink on the overall light-blocking label 100 can be measured in terms of L values and opacity. Generally speaking, using metallic flake pigments having a smaller average particle size results in a light-blocking label 100 that is less lustrous, having a higher opacity and more of a gray hue resulting in a lower L value. Generally speaking, using metallic flake pigments having a larger average particle size results in a light-blocking label 100 that is more lustrous, having a lower opacity and more of a silver hue resulting in a higher L value. Without being bound by theory, the impact on appearance of the light-blocking label 100 due to particle size of the metallic flake pigment is believed to be due to, at least in part, the amount of light reflected by the metallic flake pigment particles, which is believed to be correlated with average particle size. In one embodiment, the light-blocking ink layer 4 includes metallic flake pigment particles having an average particle size (e.g., the D50 median particle size) greater than or equal to 4 microns and less than or equal to 15 microns, alternatively greater than or equal to 4 microns and less than or equal to 8 microns, and alternatively still approximately 6 microns. Alternatively, the light-blocking ink 4 includes metallic flake pigment particles having an average particle size equal to approximately 11 microns.

The geometry of the metallic flake pigments utilized in the metallic ink can affect the appearance of the light-blocking label 100. Generally speaking, as the aspect ratio of the metallic flake (e.g., a ratio between the reflecting surface area and the flake thickness) increases, the L value of the label 100 increases. Metallic flakes produced by physical vapor deposition (PVD) will, generally speaking, result in a label 100 having higher L values than a similar label 100 incorporating metallic flakes produced by a wet-milling process (corn flakes). Without being bound by theory, the impact using PVD metallic flakes instead of corn-flake metallic flakes on L value is believed to be at least partially due to a difference in average thickness between PVD metallic flakes (angstroms) and metallic corn flakes (microns), leading to a much higher aspect ratio for the PVD metallic flakes. Similarly, the regularity of the geometry of metallic flake particles also has an impact on the appearance of a light-blocking label. For example, a metallic flake having a disc shape tends to result in a higher L-value than a metallic flake having a similar thickness and a less regular, corn flake shape. Without being bound by theory, this difference is believed to be due to the shape of the reflective surface on the amount of light reflected. Generally speaking, PVD metallic flakes will have a greater L-value (which is believed to be due to a higher reflectance) than disc-shaped metallic flakes, which in turn have a higher L-value than corn flake-shaped metallic flakes.

One non-limiting example of a metallic ink that could impart or improve light-blocking characteristics of the washable, light-blocking ink layer 4 is the INX-1661572 ink (supplied by INX International Ink Co.). Other non-limiting examples of a metallic ink that could impart or improve light-blocking characteristics of the washable-light-blocking ink layer 4 are the Novamet 2351 and the Novamet 2355 inks (supplied by Multi-Color Corporation), wherein the metallic flake pigments of Novamet 2355 (approximately 11 microns) have a greater average size than the metallic flake pigments of Novamet 2351 (approximately 6 microns). Additionally or alternatively, the light-blocking ink layer 4 may include a colored ink that is configured to absorb light, thereby improving the light-blocking properties of the label 100. In one such embodiment, the light-blocking ink layer 4 is or includes a black ink. A light-blocking ink layer 4 including a colored ink configured to absorb light, such as a black ink, generally speaking results in a light-blocking label 100 with a lower L-value and a higher opacity value when compared to a comparable light-blocking label not including the light-blocking ink layer 4.

The light-blocking ink layer 4 may include a diluent. The diluent may include, for example, propyl acetate, ethanol, ethyl acetate, some other organic solvent, or some combination thereof. In one such embodiment, the diluent includes 80% propyl acetate and 20% ethanol. In another such embodiment, the diluent includes 40% propyl acetate, 40% ethyl acetate, and 20% ethanol. The diluent may be prepared by mixing the one or more ingredients on the basis of molarity, alternatively on the basis of weight, or alternatively still on the basis of volume. In one embodiment, a diluent is added to the light-blocking ink layer 4 in order to control the viscosity and/or the percent solids. The viscosities for all embodiments of inks and varnishes discussed below were measured using a Zahn #2 viscosity cup unless otherwise indicated. The viscosity of the ink used for the light-blocking ink layer 4 may be greater than or equal to 14 seconds and less than or equal to 63 seconds, alternatively greater than or equal to 14 seconds and less than or equal to 30 seconds, alternatively greater than or equal to 18 seconds and less than or equal to 22 seconds, alternatively greater than or equal to 19 seconds and less than or equal to 21 seconds, or alternatively still greater than or equal to 18 seconds and less than or equal to 20 seconds. In one embodiment, the viscosity of the ink used for the light-blocking ink 4 is greater than the viscosity of the ink used for the ink layer 6 (discussed below).

All viscosity measurements, values, and/or ranges in the present application that are expressed in seconds using a Zahn #2 viscosity cup may be substituted with measurements, values, and/or ranges of viscosity in centipoise units using the following substitutions: 14 seconds may be substituted with 5 centipoise; 18 seconds may be substituted with 20 centipoise; 19 seconds may be substituted with 25 centipoise; 20 seconds may be substituted with 30 centipoise; 21 seconds may be substituted with 35 centipoise; 22 seconds may be substituted with 40 centipoise; 30 seconds may be substituted with 70 centipoise; and 63 seconds may be substituted with 150 centipoise. Accordingly, any viscosity measurement, value, and/or range disclosed in the application expressed in seconds using a Zahn #2 cup should be understood to disclose equivalent measurements, values, and/or ranges in centipoise using the substitutions above.

The ink layer 6 is configured to be removed from the article made of PET (not shown) and the light-blocking label 100 during at least one of a wash step or a caustic bath recycling step. In some embodiments, the ink layer 6 is configured to dissolve, disperse, or fragment when subjected to a caustic bath recycling step. In such embodiments, the ink layer 6 may be understood to be a washable ink layer 6. In other embodiments, the washable ink layer 6 is configured to dissolve, disperse, or fragment during a wash step prior to any caustic bath recycling step. Preferably, the washable ink layer 6 is configured to be removed from the light-blocking label 100 in a manner such that it is not redeposited on recycled PET (i.e., recyclate) prior to collection. Such an embodiment may include a washable ink such as, but not limited to, a washable gravure ink or a washable flexographic ink. Non-limiting examples of the washable ink used include SunSpectro Solvawash GR and SunSpectro Solvawash FL (supplied by Sun Chemical) and Genesis GS gravure inks (supplied by INX International Ink Co.).

In various embodiments, the ink layer 6 is used to apply a graphic, color, and/or text to the light-blocking label 100. The ink layer 6 may be applied to the light-blocking label 100 using any conventional printing process, including but not limited to flexographic, rotary screen, lithography, digital, gravure, letterpress, and any combination of conventional printing methods.

The ink layer 6 may include a diluent. The diluent may include, for example, propyl acetate, ethanol, ethyl acetate, some other organic solvent, or some combination thereof. In one such embodiment, the diluent includes 80% propyl acetate and 20% ethanol. In another such embodiment, the diluent includes 40% propyl acetate, 40% ethyl acetate, and 20% ethanol. The diluent may be prepared by mixing the one or more ingredients on the basis of molarity, alternatively on the basis of weight, or alternatively still on the basis of volume. In one embodiment, a diluent is added to the ink layer 6 in order to control the viscosity and/or the percent solids. The viscosity of the ink used for the ink layer 6 may be greater than or equal to 14 seconds and less than or equal to 63 seconds, alternatively greater than or equal to 14 seconds and less than or equal to 30 seconds, alternatively greater than or equal to 18 seconds and less than or equal to 22 seconds, alternatively greater than or equal to 19 seconds and less than or equal to 21 seconds, or alternatively still greater than or equal to 18 seconds and less than or equal to 20 seconds. In one embodiment, the viscosity of the ink used for the ink layer 6 is less than the viscosity of the ink used for the light-blocking ink layer 4.

The ink layer 6 may be or include a colored ink and/or a white ink. In one embodiment, the ink layer 6 is or includes one or more bump of a white ink (see discussion of white ink 5 below). In another embodiment, the ink layer 6 is or includes one or more bump of a colored ink (see discussion of color ink layer 7 below). In yet another embodiment, the ink layer 6 includes both one or more bump of a white ink and one or more bump of one or more colored ink.

It will be recognized by those of ordinary skill in the art that, while the light blocking ink layer 4 and the ink layer 6 are described above and elsewhere herein as including one type of ink, light-blocking labels of the present invention such as light-blocking label 100 and others discussed below may include multiple types of inks in a single layer (such as multiple types of inks used in a light-blocking ink layer 4 and/or multiple types of inks used in an ink layer 6) represented as a single layer. Embodiments of the invention may include one or more bump (i.e., coating) of the same type of ink (such as multiple bumps of an ink used in a light-blocking ink layer 4 and/or multiple bumps of an ink used in an ink layer 6) represented as a single layer. For example, an embodiment of the invention may include a light-blocking ink layer 4 and/or an ink layer 6 having 1 bump, alternatively having greater than or equal to 2 bumps, alternatively still having greater than or equal to 3 bumps, or yet still alternatively having greater than or equal to 5 bumps of one or more type of ink. The number of bumps of any type of ink used in an ink layer (e.g., light-blocking ink layer 4, ink layer 6, etc.) may depend on the desired or selected thickness of the ink layer. The thickness of an ink layer is correlated with the coat weight of an ink layer, which measures the difference in weight of a ream of a label substrate before and after one or more bump of ink is applied thereto. The coat weight of an ink layer (e.g., the light-blocking ink layer 4, ink layer 6, etc.), meaning the coat weight of all bumps of ink in said ink layer, may be approximately 1 lb./ream. In a further embodiment, a single ink layer may include multiple types of inks, of which one or more type of ink may have multiple bumps. In one such embodiment, a light-blocking ink layer 4 includes at least one bump of a metallic ink and at least one bump of a colored ink.

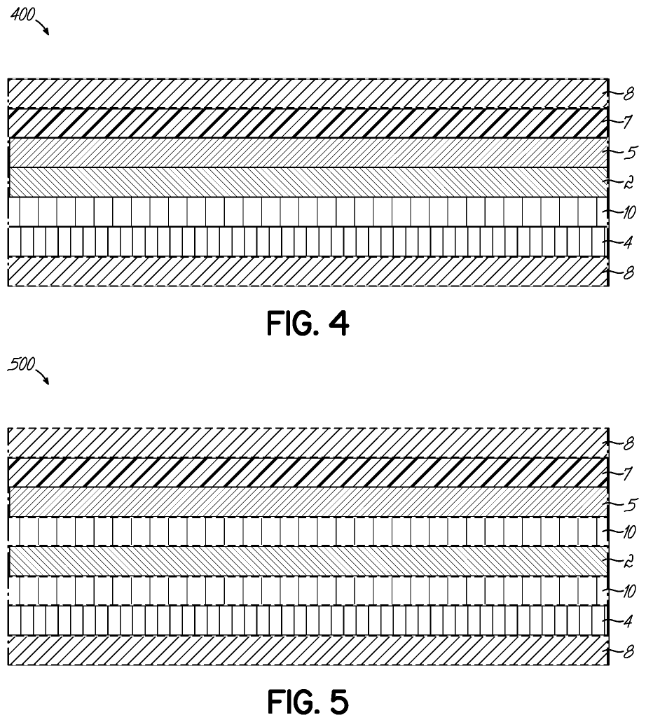

The optional varnish layer 8 may be configured to protect one or more ink layer from deformation or damage during use of the light-blocking label 100. The ink layer protected from deformation or damage by the optional varnish layer 8 may include, for example, the light-blocking ink layer 4, the optional ink layer 6, the white ink layer 5 (see discussion of FIG. 2 below), and/or the color ink layer 7 (see discussion of FIG. 2 below). In some embodiments, the optional varnish layer 8 is configured to function as an overprint varnish of the label. The optional varnish layer 8 used may be solvent based, including but not limited to a solvent gravure varnish. In some embodiments, the optional varnish layer 8 is configured to be resistant to caustic solutions, such as those conventionally used in the caustic bath recycling step. In other embodiments, the optional varnish layer 8 is configured to dissolve, disperse, or fragment when subjected to one or more of a wash step or a caustic bath recycling step. In one such embodiment, the optional varnish layer 8 is included and configured to disperse or fragment when subjected to a wash step. In another such embodiment, the optional varnish layer 8 is included and configured to disperse or fragment when subjected to a caustic bath recycling step.

The optional varnish layer 8 may be configured to be transparent so as to not to obstruct view of the layer above or below. In some embodiments, the thickness of the optional varnish layer 8 is greater than or equal to 50 nm and less than or equal to 10 μm. In other embodiments, the thickness of the optional varnish layer 8 is greater than or equal to 50 nm and less than or equal to 1 μm. The optional varnish layer 8 may be applied as a continuous coating, as a pattern, or in any other conventional method of application.

One non-limiting example of an optional varnish layer 8 which may be used with embodiments of the current invention is SunCure® HG (High Gloss) TL 4098 coating (commercially available under product number RCYFV484098) supplied by Sun Chemical. Other non-limiting examples of a varnish or coating layer that may be used in embodiments of the present invention include the UP 1505 and UP 3707 overprint varnishes (supplied by Hi-Tech Coatings).

The optional varnish layer 8 may include a diluent. The diluent may include, for example, propyl acetate, ethanol, ethyl acetate, some other organic solvent, or some combination thereof. In one such embodiment, the diluent includes 80% propyl acetate and 20% ethanol. In another such embodiment, the diluent includes 40% propyl acetate, 40% ethyl acetate, and 20% ethanol. The diluent may be prepared by mixing the one or more ingredients on the basis of molarity, alternatively on the basis of weight, or alternatively still on the basis of volume. In one embodiment, a diluent is added to the optional varnish layer 8 in order to control the viscosity and/or the percent solids. The viscosity of the varnish used for the optional varnish layer 8 may be greater than or equal to 14 seconds and less than or equal to 63 seconds, alternatively greater than or equal to 14 seconds and less than or equal to 30 seconds, alternatively greater than or equal to 18 seconds and less than or equal to 22 seconds, alternatively greater than or equal to 19 seconds and less than or equal to 21 seconds, or alternatively still greater than or equal to 18 seconds and less than or equal to 20 seconds.

With reference now to FIG. 2, another embodiment of a light-blocking label 200 in accordance with the principles of the present invention is shown. It should be understood that layer(s) discussed below with numbers matching layers in previously discussed embodiments may have the same properties as previously described unless otherwise indicated. As shown, the light-blocking label 200 includes a label substrate 2 that is positioned above a light-blocking ink layer 4 and below a white ink layer 5. In this embodiment, a label substrate 2 is positioned between the light-blocking ink layer 4 and the white ink layer 5. In a further embodiment, the label substrate 2 is positioned directly between both the light-blocking ink layer 4 and the white ink layer 5. The light-blocking label 200 further includes a color ink layer 7 above the white ink layer 5. In one embodiment, the color ink layer 7 is directly above the white ink layer 5. The light-blocking label 100 may further include an optional varnish layer 8. The optional varnish layer 8 may be positioned above the color ink layer 7, below the light-blocking ink layer 4, or both. In some further embodiments, the optional varnish layer 8 is positioned directly above the color ink layer 7. In some further embodiments, the optional varnish layer 8 is positioned directly below the light-blocking ink layer 4. In embodiments where the light-blocking label 200 includes a label substrate 2 that is recyclable with the article to which it is attached and all other layers are configured to be removable therefrom in a wash step and/or caustic bath step, the light-blocking label 200 may be a recyclable light-blocking label 200.

The white ink layer 5 may be configured to be removed from the article made of PET (not shown) and the light-blocking label 200 during at least one of a wash step or a caustic bath recycling step. In such embodiments, the white ink layer 5 may be understood to be a washable, white ink layer 5. Such an embodiment may include a washable ink such as, but not limited to, a washable gravure ink or a washable flexographic ink. In some embodiments, the washable, white ink layer 5 is configured to dissolve, disperse, or fragment when subjected to a caustic bath recycling step. In other embodiments, the washable, white ink layer 5 is configured to dissolve, disperse, or fragment during a wash step prior to any caustic bath recycling step. Preferably, the washable, white ink layer 5 is configured to be removed from the light-blocking label 200 in a manner such that it is not redeposited on recycled PET prior to collection.

The white ink layer 5 may be used to set a base color for the light-blocking label 200 or to apply a graphic and/or text to the light-blocking label 200. The white ink layer 5 may be applied to the light-blocking label 200 using any conventional printing process, including but not limited to flexographic, rotary screen, lithography, digital, gravure, letterpress, and any combination of conventional printing methods.

The inclusion of the white ink layer 5 in the light-blocking label 200 may impact the light-blocking characteristics and/or appearance of the light-blocking label 200. Generally speaking, the inclusion of the white ink layer 5 results in a light-blocking label 200 having a greater L value when compared to a comparable label not including a white ink layer 5. Generally speaking, the inclusion of a white ink layer 5 including a greater number of white ink bumps results in a light-blocking label 200 having a greater L-value when compared to a comparable label having a lesser number of white ink bumps or no white ink bumps. Such an embodiment may include a washable ink such as, but not limited to, a washable gravure ink or a washable flexographic ink. Non-limiting examples of the washable ink used include SunSpectro Solvawash GR and SunSpectro Solvawash FL (supplied by Sun Chemical) and Genesis GS gravure inks (supplied by INX International Ink Co.). Other non-limiting examples of a washable white ink that could be used in the washable, white ink layer 5 include the INX-1671985 ink, the INX-1671091 ink, and the INX-164308 ink (supplied by INX International Ink Co.).

The white ink layer 5 may include a diluent. The diluent may include, for example, propyl acetate, ethanol, ethyl acetate, some other organic solvent, or some combination thereof. In one such embodiment, the diluent includes 80% propyl acetate and 20% ethanol. In another such embodiment, the diluent includes 40% propyl acetate, 40% ethyl acetate, and 20% ethanol. The diluent may be prepared by mixing the one or more ingredients on the basis of molarity, alternatively on the basis of weight, or alternatively still on the basis of volume. In one embodiment, a diluent is added to the white ink layer 5 in order to control the viscosity and/or the percent solids. The viscosity of the ink used for the white ink layer 5 may be greater than or equal to 14 seconds and less than or equal to 63 seconds, alternatively greater than or equal to 14 seconds and less than or equal to 30 seconds, alternatively greater than or equal to 18 seconds and less than or equal to 22 seconds, alternatively greater than or equal to 19 seconds and less than or equal to 21 seconds, or alternatively still greater than or equal to 18 seconds and less than or equal to 20 seconds. In one embodiment, the viscosity of the ink used for the white ink layer 5 is less than the viscosity of the ink used for the light-blocking ink layer 4.

The color ink layer 7 may be configured to be removed from the article made of PET (not shown) and the light-blocking label 200 during at least one of a wash step or a caustic bath recycling step. In such embodiments, the color ink layer 7 may be understood to be a washable, color ink layer 7. Such an embodiment may include a washable ink such as, but not limited to, a washable gravure ink or a washable flexographic ink. Non-limiting examples of the washable ink used include SunSpectro Solvawash GR and SunSpectro Solvawash FL (supplied by Sun Chemical) and Genesis GS gravure inks (supplied by INX International Ink Co.). A non-limiting example of a Genesis GS gravure ink that can be used in the color ink layer 7 is the GENY-0108C yellow ink. In some embodiments, the washable, color ink layer 7 is configured to dissolve, disperse, or fragment when subjected to a caustic bath recycling step. In other embodiments, the washable, color ink layer 7 is configured to dissolve, disperse, or fragment during a wash step prior to any caustic bath recycling step. Preferably, the washable, color ink layer 7 is configured to be removed from the light-blocking label 200 in a manner such that it is not redeposited on recycled PET prior to collection.

In various embodiments, the color ink layer 7 is used to apply a graphic, color, and/or text to the light-blocking label 200. The color ink layer 7 may be applied to the light-blocking label 200 using any conventional printing process, including but not limited to flexographic, rotary screen, lithography, digital, gravure, letterpress, and any combination of conventional printing methods. Such an embodiment may include a washable ink such as, but not limited to, a washable gravure ink or a washable flexographic ink. Non-limiting examples of the washable ink used include SunSpectro Solvawash GR and SunSpectro Solvawash FL (supplied by Sun Chemical) and Genesis GS gravure inks (supplied by INX International Ink Co.). A non-limiting example of a Genesis GS gravure ink that can be used in the color ink layer 7 is the GENY-0108C yellow ink.

The color ink layer 7 may include a diluent. The diluent may include, for example, propyl acetate, ethanol, ethyl acetate, some other organic solvent, or some combination thereof. In one such embodiment, the diluent includes 80% propyl acetate and 20% ethanol. In another such embodiment, the diluent includes 40% propyl acetate, 40% ethyl acetate, and 20% ethanol. The diluent may be prepared by mixing the one or more ingredients on the basis of molarity, alternatively on the basis of weight, or alternatively still on the basis of volume. In one embodiment, a diluent is added to the color ink layer 7 in order to control the viscosity and/or the percent solids. The viscosity of the ink used for the color ink layer 7 may be greater than or equal to 14 seconds and less than or equal to 63 seconds, alternatively greater than or equal to 14 seconds and less than or equal to 30 seconds, alternatively greater than or equal to 18 seconds and less than or equal to 22 seconds, alternatively greater than or equal to 19 seconds and less than or equal to 21 seconds, or alternatively still greater than or equal to 18 seconds and less than or equal to 20 seconds. In one embodiment, the viscosity of the ink used for the color ink layer 7 is less than the viscosity of the ink used for the light-blocking ink layer 4.

It will be recognized by those of ordinary skill in the art that, while the light blocking ink layer 4, the white ink layer 5, and the color ink layer 7 are described above and elsewhere herein, light-blocking labels of the present invention such as light-blocking label 200 and others discussed below may include multiple types of inks in a single layer (such as multiple types of inks in the light-blocking ink layer 4, the white ink layer 5, and/or in the color ink layer 7). Similarly, embodiments of the invention may include one or more bump (i.e., coating) of the same type of ink. For example, an embodiment of the invention may include a light-blocking ink layer 4, a white ink layer 5, and/or a color ink layer 7 having 1 bump, alternatively having greater than or equal to 2 bumps, alternatively still having greater than or equal to 3 bumps, or yet still alternatively having greater than or equal to 5 bumps of one or more type of ink. The number of bumps of any type of ink used in an ink layer may depend on the desired or selected thickness of the ink layer, which is correlated with the coat weight of an ink layer as discussed above. The coat weight of an ink layer (e.g., the light-blocking ink layer 4, white ink layer 5, color ink layer 7, etc.), meaning the coat weight of all bumps of ink in said ink layer, may be approximately 1 lb./ream. In a further embodiment, a single ink layer (e.g., the color ink layer 7) may include multiple types of inks, of which one or more types of inks may have multiple bumps. In one such embodiment, the color ink layer 7 encompasses all process colors and all spot colors.

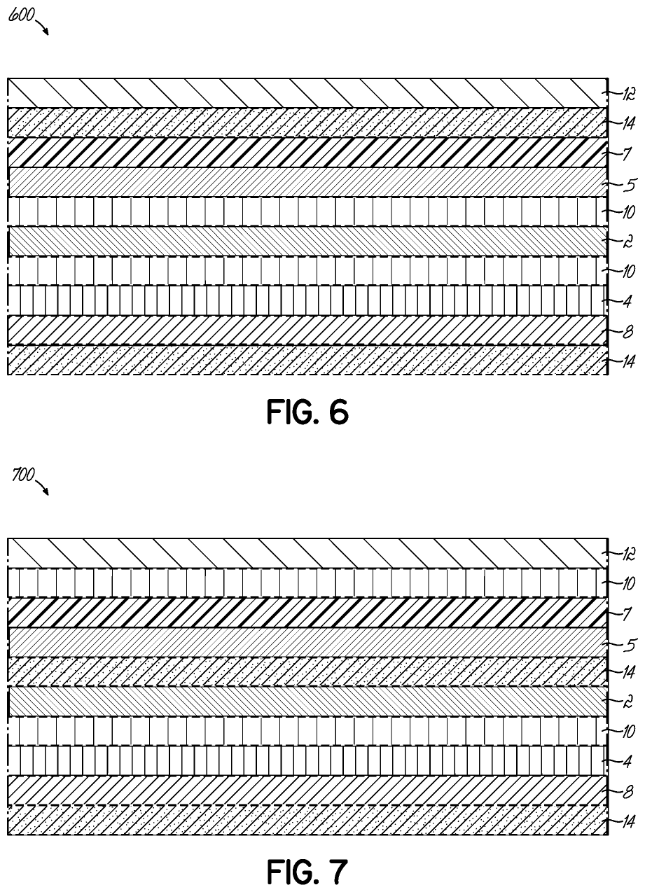

With reference now to FIGS. 3-5, other embodiments of light-blocking labels in accordance with the principles of the present invention are shown. It should be understood that layer(s) discussed below with numbers matching layers in previously discussed embodiments may have the same properties as previously described unless otherwise indicated. FIGS. 3-5 show light-blocking labels 300, 400, 500 respectively which include a label substrate 2 that is positioned above a light-blocking ink layer 4 and below a white ink layer 5. The light-blocking labels 300, 400, 500 further include a color ink layer 7 above the white ink layer 5 and may further include one or more optional varnish layer 8. The optional varnish layer 8 may be positioned above the color ink layer 7, below the light-blocking ink layer 4, or both. In some further embodiments, the optional varnish layer 8 is positioned directly above the color ink layer 7. In some further embodiments, the optional varnish layer 8 is positioned directly below the light-blocking ink layer 4. In embodiments where the light-blocking label 300, 400, 500 includes a label substrate 2 that is recyclable with the article to which it is attached and all other layers are configured to be removable therefrom in a wash step and/or caustic bath step, the light-blocking label 300, 400, 500 may be a recyclable light-blocking label 300, 400, 500.

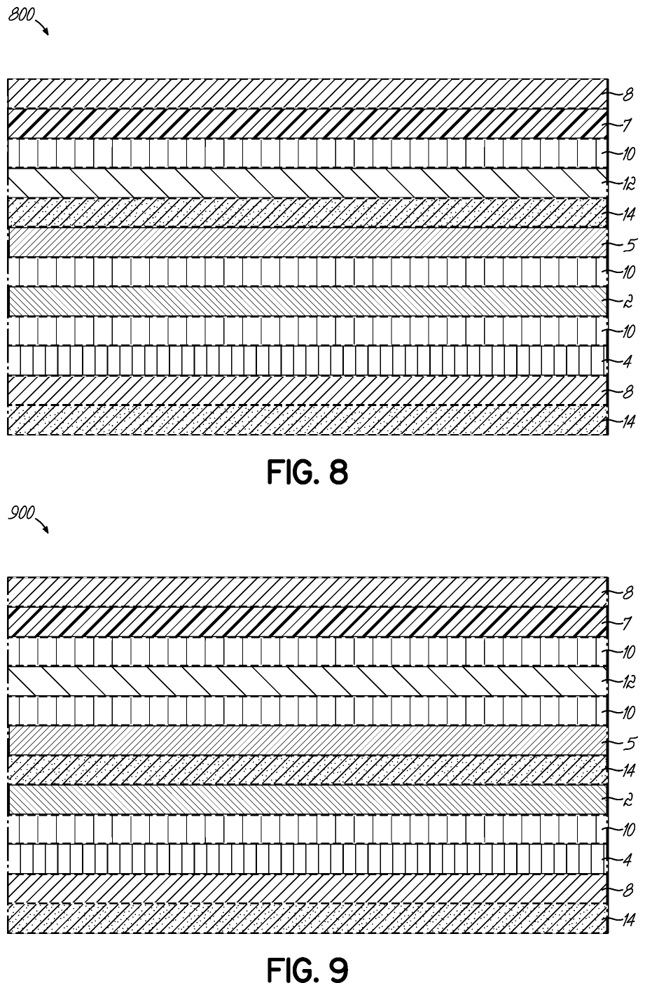

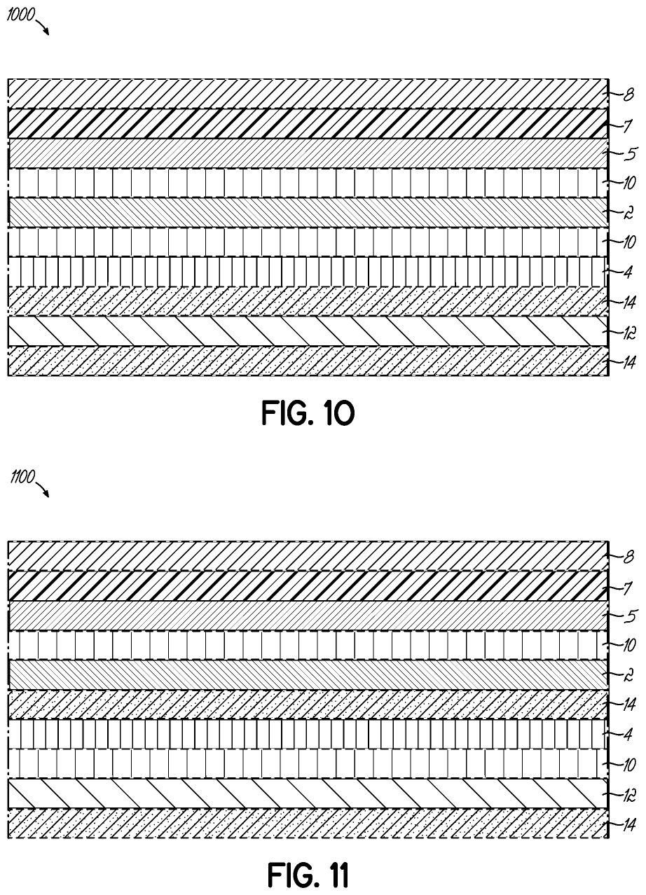

Light-blocking labels 300, 400, 500 differ from the light-blocking label 200 at least because light-blocking labels 300, 400, 500 further include one or more ink primer layer 10. With reference to FIG. 3, the light-blocking label 300 includes an ink primer layer 10 that is positioned between the white ink layer 5 and the label substrate 2. In one embodiment, the ink primer layer 10 is positioned directly between the white ink layer 5 and the label substrate 2. With reference to FIG. 4, the light-blocking label 400 includes an ink primer layer 10 that is positioned between the label substrate 2 and the light-blocking ink layer 4. In one embodiment, the ink primer layer 10 is positioned directly between the label substrate 2 and the light-blocking ink layer 4. With reference to FIG. 5, the light-blocking label 500 includes one or more ink primer layer 10. The one or more ink primer layer 10 may be positioned between the white ink layer 5 and the label substrate 2, between the label substrate 2 and the light-blocking ink layer 4, or in both positions. As shown in FIG. 5, there are at least two ink primer layers 10—one between the white ink layer 5 and the label substrate 2 and another between the label substrate 2 and the light-blocking ink layer 4.

The ink primer layer 10 may include materials that are configured to be reactive with a caustic bath. In some such embodiments, the ink primer layer 10 is configured to react with a caustic bath such that the ink primer layer 10 is not collected along with the recycled PET stream. Examples of materials for an ink primer layer 10 that is configured to react with a caustic bath include, but are not limited to, polyvinyl esters, polyacrylates, or other materials with suitable dissolution characteristics when subjected to basic aqueous mediums such as a caustic bath. The ink primer layer 10 may be configured to react during a wash step such that the ink primer layer 10 is not collected along with the recycled PET stream.

In some embodiments, the ink primer layer 10 is configured to receive an ink discussed in the various embodiments above, such as the white ink layer 5 or the light-blocking ink layer 4. The ink primer layer 10 may increase the binding affinity of such an ink to the light-blocking label 300, 400, 500. In such embodiments, the ink primer layer 10 may be applied directly to the label substrate 2, followed by applying the ink to the ink primer layer 10.

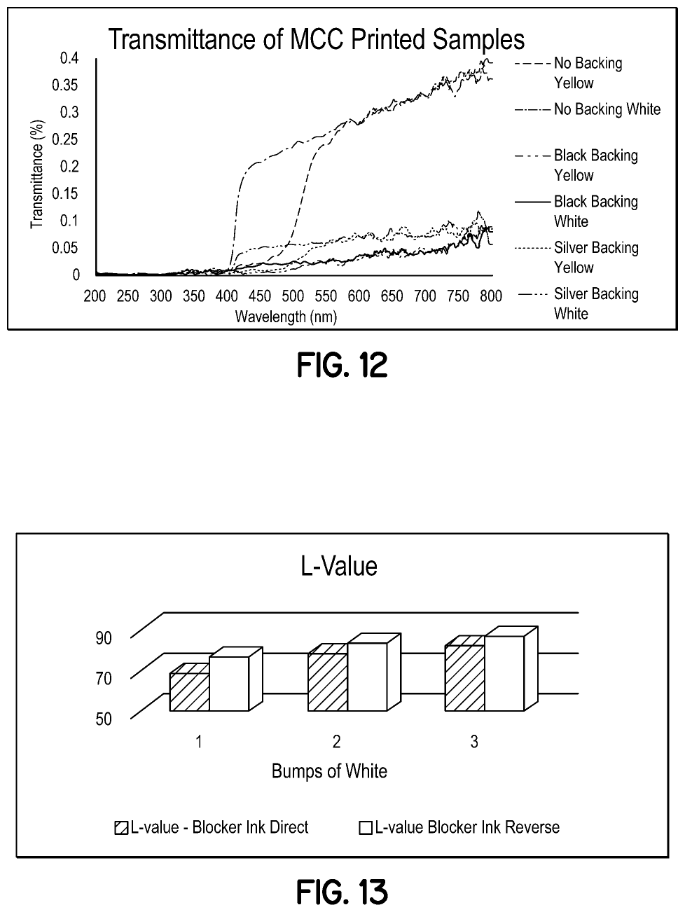

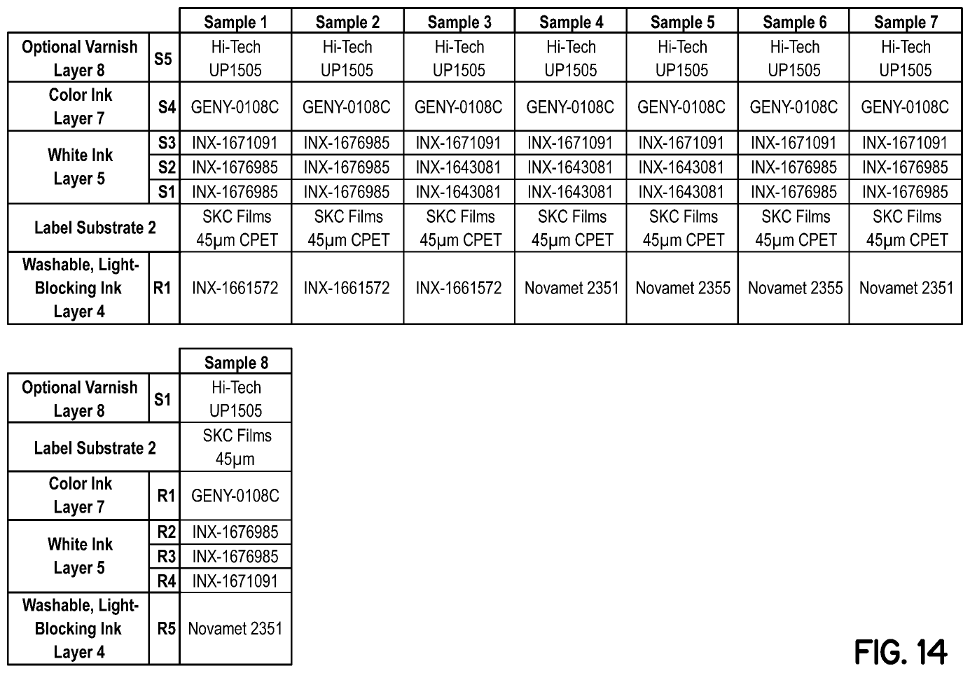

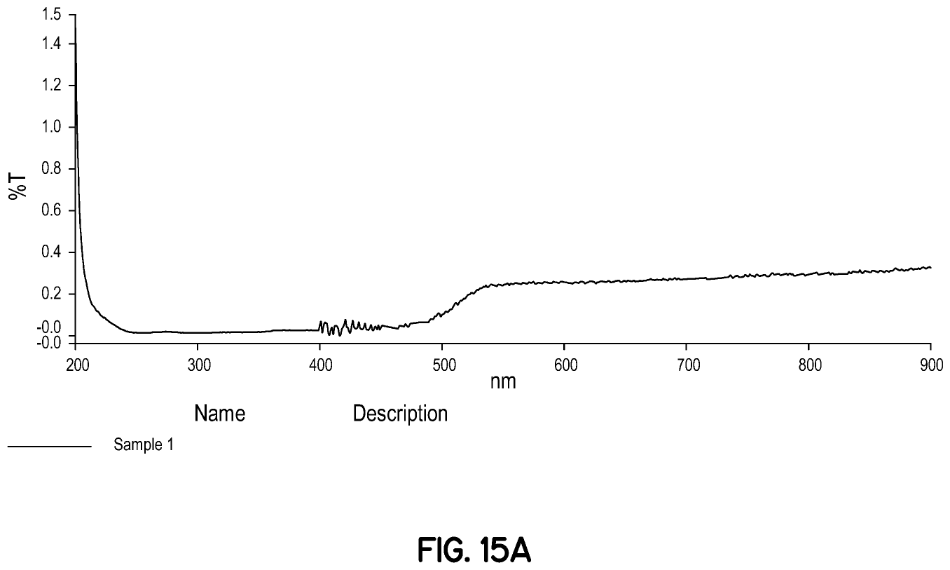

With reference to FIGS. 6-11, other embodiments of light-blocking labels in accordance with the principles of the present invention are shown. It should be understood that layer(s) discussed below with numbers matching layers in previously discussed embodiments may have the same properties as previously described unless otherwise indicated. FIGS. 6-11 show light-blocking labels 600, 700, 800, 900, 1000, 1100 respectively which include a label substrate 2 that is positioned above a light-blocking ink layer 4 and below a white ink layer 5. The light-blocking labels 600, 700, 800, 900, 1000, 1100 further include a color ink layer 7 above the white ink layer 5. The light-blocking labels 600, 700, 800, 900, 1000, 1100 may further include one or more optional varnish layer 8, one or more optional ink primer layer 10, and/or one or more optional adhesive layer 14. With reference to FIGS. 6-7, the optional varnish layer 8 may be positioned below the light-blocking ink layer 4. With reference to FIGS. 8-11, the optional varnish layer 8 may be positioned above the color ink layer 7, below the light-blocking ink layer 4, or both.

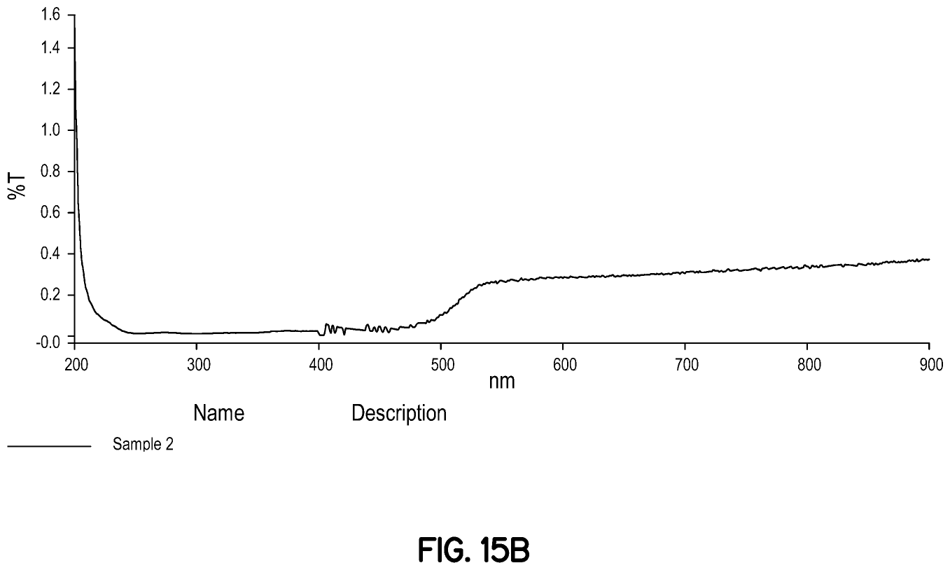

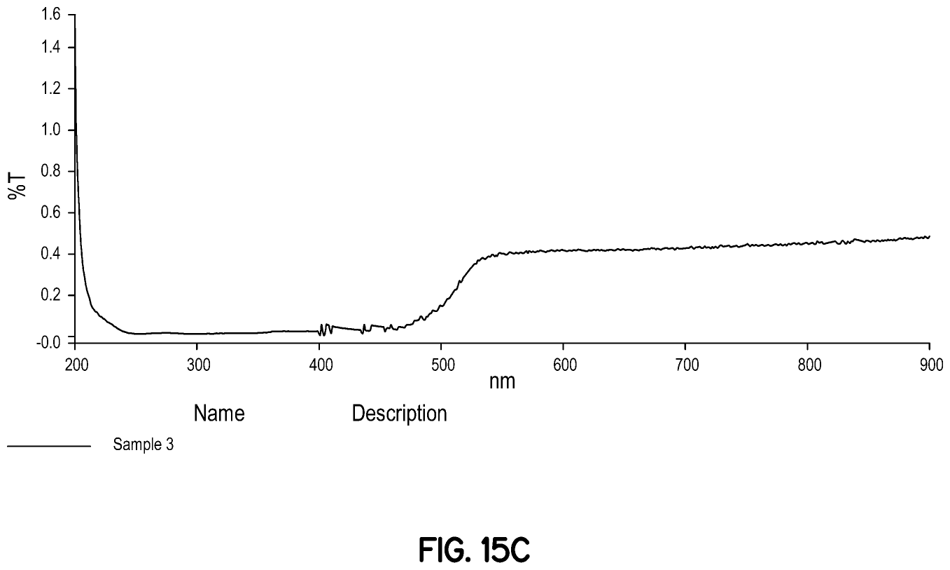

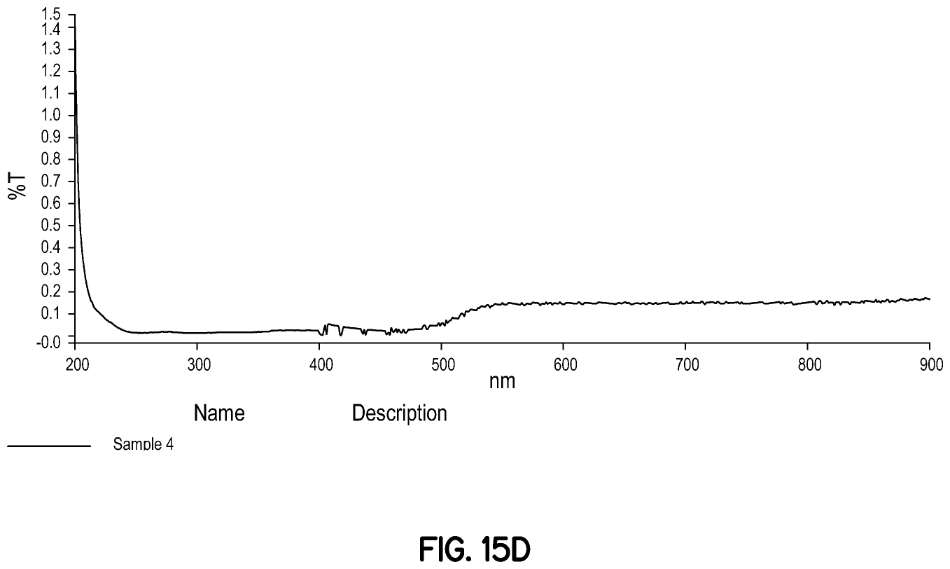

With continued reference to FIGS. 6-11, light-blocking labels 600, 700, 800, 900, 1000, 1100 differ from the light-blocking label 500 at least because light-blocking labels 600, 700, 800, 900, 1000, 1100 further include a second label substrate 12. With reference to FIGS. 6 and 7, the light-blocking labels 600, 700 include second label substrate 12 that is positioned above the color ink layer 7. With reference to FIGS. 8 and 9, the light-blocking labels 800, 900 include a second label substrate 12 that is positioned below the color ink layer 7 and above the white ink layer 5. With reference to FIGS. 10 and 11, the light-blocking labels 1000, 1100 include a second label substrate 12 that is positioned below the light-blocking ink layer 4. In embodiments where the light-blocking label 600, 700, 800, 900, 1000, 1100 includes a label substrate 2 and second label substrate 12 that are recyclable with the article to which it is attached and all other layers are configured to be removable therefrom in a wash step and/or caustic bath step, the light-blocking label 600, 700, 800, 900, 1000, 1100 may be a recyclable light-blocking label 600, 700, 800, 900, 1000, 1100.

Referring now to FIG. 6, an optional varnish layer 8 may be positioned below the light-blocking ink layer 4. In one embodiment, an optional varnish layer 8 may be positioned directly below the light-blocking ink layer 4. One or more optional ink primer layer 10 may be positioned between the white ink layer 5 and the label substrate 2, between the label substrate 2 and the light-blocking ink layer 4, or both. In one embodiment, an optional ink primer layer 10 is positioned directly between the white ink layer 5 and the label substrate 2. Alternatively or additionally, an optional ink primer layer 10 may be positioned directly between the label substrate 2 and the light-blocking ink layer 4. One or more optional adhesive layer 14 may be positioned below the second label substrate 12, below the light-blocking ink layer 4, or both.

Referring now to FIG. 7, an optional varnish layer 8 may be positioned below the light-blocking ink layer 4. In one embodiment, an optional varnish layer 8 may be positioned directly below the light-blocking ink layer 4. One or more optional ink primer layer 10 may be positioned between the second label substrate 12 and the color ink layer 7, between the label substrate 2 and the light-blocking ink layer 4, or both. In one embodiment, an optional ink primer layer 10 is positioned directly between the second label substrate 12 and the color ink layer 7. Alternatively or additionally, an optional ink primer layer 10 may be positioned directly between the label substrate 2 and the light-blocking ink layer 4. One or more optional adhesive layer 14 may be positioned below the second label substrate 12, below the light-blocking ink layer 4, or both.

Referring now to FIG. 8, one or more optional varnish layer 8 may be positioned above the color ink layer 7, below the light-blocking ink layer 4, or both. In one embodiment, an optional varnish layer 8 is positioned directly above the color ink layer 8. Additionally or alternatively, an optional varnish layer 8 is positioned directly below the light-blocking ink layer 4. One or more optional primer layer 10 may be included between the color ink layer 7 and the second label substrate 12, between the white ink layer 5 and the label substrate 2, between the label substrate 2 and the light-blocking ink 4, or all of the above. In one embodiment, an optional primer layer 10 is positioned directly between the color ink layer 7 and the second label substrate 12. Additionally or alternatively, an optional ink primer layer 10 is included directly between the white ink layer 5 and the label substrate 2. Additionally or alternatively, an optional ink primer layer 10 is included directly between the label substrate 2 and the light-blocking ink layer 4. One or more optional adhesive layer 14 may be positioned between the second label substrate 12 and the white ink layer 5, below the light-blocking ink layer 4, or both.

Referring now to FIG. 9, one or more optional varnish layer 8 may be positioned above the color ink layer 7, below the light-blocking ink layer 4, or both. In one embodiment, an optional varnish layer 8 is positioned directly above the color ink layer 8. Additionally or alternatively, an optional varnish layer 8 is positioned directly below the light-blocking ink layer 4. One or more optional primer layer 10 may be included between the color ink layer 7 and the second label substrate 12, between the second label substrate 12 and the white ink layer 5, between the label substrate 2 and the light-blocking ink 4, or all of the above. In one embodiment, an optional primer layer 10 is positioned directly between the color ink layer 7 and the second label substrate 12. Additionally or alternatively, an optional ink primer layer 10 is included directly between the second label substrate 12 and the white ink layer 5. Additionally or alternatively, an optional ink primer layer 10 is included directly between the label substrate 2 and the light-blocking ink layer 4. One or more optional adhesive layer 14 may be positioned between the white ink layer 5 and the label substrate 2, below the light-blocking ink layer 4, or both.

Referring now to FIG. 10, an optional varnish layer 8 may be positioned above the color ink layer 7. In one embodiment, an optional varnish layer is included directly above the color ink layer 7. One or more optional ink primer layer 10 may be positioned between the white ink layer 5 and the label substrate 2, between the label substrate 2 and the light blocking ink layer 4, or both. In one embodiment, an optional ink primer layer 10 is positioned directly between the white ink layer 5 and the label substrate 2. Additionally or alternatively, an optional ink primer layer 10 is positioned directly between the label substrate 2 and the light-blocking ink layer 4. One or more optional adhesive layer 14 may be positioned between the light-blocking ink layer 4 and the second label substrate 12, below the second label substrate 12, or both.

Referring now to FIG. 11, an optional varnish layer 8 may be positioned above the color ink layer 7. In one embodiment, an optional varnish layer is included directly above the color ink layer 7. One or more optional ink primer layer 10 may be positioned between the white ink layer 5 and the label substrate 2, between the light blocking ink layer 4 and the second label substrate 12, or both. In one embodiment, an optional ink primer layer 10 is positioned directly between the white ink layer 5 and the label substrate 2. Additionally or alternatively, an optional ink primer layer 10 is positioned directly between the light-blocking ink layer 4 and the second label substrate 12. One or more optional adhesive layer 14 may be positioned between the label substrate 2 and the light-blocking ink layer 4, below the second label substrate 12, or both.

In that regard, the second label substrate 12 is configured to be compatible with the article made of PET during recycling. For example, for articles made out of PET, the second label substrate 12 may include PET, resins designed to be compatible with PET recycling, crystallized PET (CPET), recycled PET (i.e., PET that includes post-consumer recycled (PCR) material), or some combination thereof. In one embodiment, the second label substrate 12 includes clear, virgin CPET. In another embodiment, the second label substrate 12 includes clear, recycled CPET (i.e., CPET that includes PCR material). In one embodiment, the second label substrate 12 includes biaxially oriented PET (BOPET). In another embodiment, the second label substrate 12 includes machine-direction oriented PET (MDO PET). In another embodiment, the second label substrate 12 includes transverse directionally oriented PET (TDO PET). One non-limiting example of a material for the label substrate 2 is the SCLRR 102435 45 μm gauge CPET film supplied by SKC Films. In one embodiment, the materials for the second label substrate 12 are the same as the materials for the label substrate 2.

The second label substrate 12 has a gauge. In some embodiments, the second label substrate 12 has a gauge greater than or equal to 10 μm and less than or equal to 100 μm. In some further embodiments, the second label substrate 12 has a gauge greater than or equal to 19 μm and less than or equal to 55 μm. In some further embodiments, the second label substrate 12 has a gauge greater than or equal to 12 μm and less than or equal to 30 μm. The gauge of the second label substrate 12 may depend, at least in part, on the article on which the light-blocking label 100 is affixed. In one embodiment, the gauge for the second label substrate 12 is the same as the gauge for the label substrate 2.

The second label substrate 12 may be configured to enable the light-blocking label to function as a shrink sleeve label. In such embodiments, the second label substrate 12 is configured to shrink when sufficient heat is applied. Alternatively, the second label substrate 12 may be configured to enable the light-blocking label to function as another type of label such as, for example, a wrap-around label, an in-mold labels, a cut-and-stack label, or a pressure-sensitive label. In one embodiment, the second label substrate 12 is configured to enable the same type of light-blocking label as the label substrate 2.

The light-blocking label 600, 700, 800, 900, 1000, 1100 may also include one or more optional adhesive layer 14. In some embodiments, an adhesive layer 14 may be included as the bottom-most layer in the light-blocking label 600, 700, 800, 900, 1000, 1100. In such embodiments, the adhesive layer 14 may be applied directly to the adjacent layer. For example, with reference to FIGS. 6-9, the bottom-most optional adhesive layer 14 may be applied directly to the optional varnish layer 8, or alternatively to the light-blocking ink layer 4 in embodiments not including the optional varnish layer 8 below the light-blocking ink layer 4. With reference to FIGS. 10-11, the bottom-most optional adhesive layer 14 may be applied directly to the second label substrate 12. In embodiments including a bottom-most layer that is an adhesive layer 14, the adhesive layer 14 that is the bottom-most layer may be configured to affix the light-blocking label 14 to the article made of PET (not shown). In some embodiments, an adhesive layer 14 may be included between the label substrate 2 and the second label substrate 12. In such embodiments, the optional adhesive layer 14 between the label substrate 2 and the second label substrate 12 may be applied directly to the adjacent second substrate layer 12 (see FIGS. 6, 8, 10) or the adjacent second substrate layer 2 (see FIGS. 7, 9, 11). In embodiments including an adhesive layer 14 between the label substrate 2 and the second label substrate 12, that optional adhesive layer 14 may be configured to affix the label substrate 2 to the second label substrate 12. The optional adhesive layer 14 may be applied to the light-blocking label at one or more point in time including, but not limited to, during production of the light-blocking label, before the light-blocking label is affixed to the article made of PET, or during the application of the light-blocking label to the article made of PET.

When included, the optional adhesive layer 14 may be of a chemistry that is configured to at least partially dissolve or disperse or fragment when subjected to a wash step or a caustic bath. In some embodiments, a portion of the optional adhesive layer 14 may remain affixed to the article made of PET when subjected to a wash step or a hot caustic bath sink-float recycle step. In other embodiments, a portion of the optional adhesive layer 14 may remain affixed to the light-blocking label 600, 700, 800, 900, 1000, 1100 when subjected to a wash step or a hot caustic bath sink-float recycling step. In other embodiments still, that optional adhesive layer 14 is configured to wash off of the article made of PET and the light-blocking label 600, 700, 800, 900, 1000, 1100 during a wash step or a hot caustic bath sink-float recycle step. In various further embodiments, the optional adhesive layer 14 is configured to dissolve or disperse or fragment into the wash solution during a wash step. In other further embodiments, the optional adhesive layer 14 is configured to dissolve or disperse or fragment in the caustic bath solution during a recycling step. In various further embodiments, the optional adhesive layer 14 is configured to be both removed from the article made of PET and not redeposited on the recycled PET prior to collection.

Although the optional adhesive layer 14 is shown to be a continuous layer co-extensive with the length of the light blocking label, other embodiments of the invention include an optional adhesive layer that is only applied to one or more portion of a light-blocking label (not shown). In some such embodiments, the optional adhesive layer may be applied to one or more discontinuous portions of the light-blocking label.

The optional adhesive layer 14 may include one or more adhesive selected so that the light-blocking label functions as a shrink sleeve label. In such embodiments, the shrink sleeve label may be configured to be affixed to the article made of PET using any conventional process for affixing shrink sleeve labels. In various embodiments, a length of the shrink sleeve label is cut to a sheet having a predetermined size based on the article from a roll, the ends of the sheet are seamed together, the seamed sheet is placed around the article, and a source of heat (e.g., steam) is applied to the seamed sheet so that the label shrinks around the article. Although using an optional adhesive layer 14 is not always necessary in affixing a shrink sleeve label to an article, it may be desirable in some embodiments to use an adhesive layer 14 including an adhesive such as a heat seal adhesive. In one such embodiment, the heat seal adhesive is used and is configured to activate during the heat application step (e.g., steam applications step) of the shrink sleeve label application process. One non-limiting example of a heat seal adhesive that may be used in such embodiments is the UP 787 adhesive (supplied by Hi-Tech Coatings).

The optional adhesive layer 14 may include one or more adhesive selected so that the light-blocking label functions as a wrap-around label. In such embodiments, the wrap-around label may be configured to be affixed to the article made out of PET using any conventional process for affixing wrap-around labels. In various embodiments, the wrap-around label is configured to be affixed to an article made of PET using a wrapping apparatus. In some embodiments, the wrap-around label is configured to be affixed to a predominantly cylindrical portion of the article made of PET. In some further embodiments, the wrap-around label is configured to be applied to the cylindrical portion of the article made of PET using a roller. In some embodiments, the bottom-most optional adhesive layer 14 is configured to be applied to the wrap-around label. The bottom-most optional adhesive layer 14 may be applied to the wrap-around label when the wrap-around label is applied to the article made of PET. In other embodiments, an adhesive layer is configured to be applied to the article made of PET (not shown). In some further embodiments, an optional adhesive layer 14 is applied to the wrap-around label and an adhesive layer is also applied to the article made of PET (not shown). It is not necessary that the wrap-around label wrap completely around the article. This may occur where the wrap-around label has a length shorter than a perimeter of the article. However, it is also possible that the wrap-around label has a length longer than the perimeter of the article such that a portion of the wrap-around label covers another portion of the wrap-around label when affixed to the article.

The optional adhesive layer 14 may be selected so that the light-blocking label functions as a pressure-sensitive label. Pressure-sensitive labels may require additional and/or different components from wrap-around labels. For example, a pressure-sensitive label may include a pressure-sensitive adhesive. An adhesive is pressure sensitive if, for example, the adhesive is activated by the application of pressure. Pressure-sensitive adhesives may be permanent or removable depending on the intended use of the pressure-sensitive label and/or the article. One non-limiting example of a pressure-sensitive adhesive that may be used in the present invention is Adhesive E5802 supplied by Avery Denison (commercially available under product name Avery Dennison Adhesive E5802).

If the pressure-sensitive adhesive is applied by the manufacturer before being obtained by the user, the pressure-sensitive label may include a liner layer (not shown) below the bottom-most optional adhesive layer 14. The liner layer is intended to come in contact with the pressure-sensitive adhesive and prevent the adhesion to unintended surfaces prior to application of the pressure-sensitive label to an article such as the article made of PET. The liner layer may include a material designed to prevent permanent adhesion of the pressure-sensitive label to the liner layer and preserve the adhesion function of the bottom-most optional adhesive layer 14. Liner layer materials that may be used to prevent permanent adhesion of the pressure-sensitive adhesive to the liner layer include, by way of example and not limitation, siliconized PET, siliconized paper, or other suitable non-stick materials.

With reference now to light-blocking labels 100, 200, 300, 400, 500, 600, 700, 800, 900, 1000, 1100, it may be preferable to maximize the L-value for the white ink layer 5 and/or the color ink layer 7 for a light-blocking label described above. The L-value is a measure of the lightness on a scale from 0 to 100, with 0 being the darkest and 100 being the lightest (with chromaticity of colored inks in CIELAB color space being represented using a-values and b-values). Generally speaking, a white ink layer 5 has an L-value close to 100. However, including the light-blocking ink layer 4 below the label substrate 2 typically will reduce the L-value of the white ink layer 5 and/or the color ink layer 7 positioned above the label substrate 2 (i.e., the color will become more grey or black). A light-blocking label including a light-blocking ink layer 4 may have an L-value greater than or equal to 80, alternatively greater than or equal to 84, alternatively still greater than or equal to 88, still alternatively greater than or equal to 92, or alternatively greater than or equal to 96.

With continued reference to light-blocking labels 100, 200, 300, 400, 500, 600, 700, 800, 900, 1000, 1100, it may be preferable to maximize the opacity of a light-blocking label. Opacity is a measure of the amount of light blocked by the light-blocking label given as a percentage of the light shone on the label. Generally speaking, including a light-blocking ink layer 4 will increase the opacity of the light-blocking label. A light-blocking label may have an opacity greater than or equal to 80%, alternatively greater than or equal to 90%, alternatively greater than or equal to 95%, still alternatively greater than or equal to 98%, or still alternatively greater than or equal to 99%. In one embodiment, the light-blocking label has an opacity greater than or equal to 98% and an L-value of the white ink layer 5 and/or the color ink layer 7 greater than or equal to 80. In another embodiment, the light-blocking label has an opacity greater than or equal to 98% and an L-value of the white ink layer 5 and/or the color ink layer 7 greater than or equal to 88.

With continued reference to light-blocking labels 100, 200, 300, 400, 500, 600, 700, 800, 900, 1000, 1100, it may be preferable to minimize the maximum transmission of one or more wavelength of light through a light-blocking label when measured using an integrated sphere. The maximum transmission when measured using an integrated sphere will indicate how much light of that one or more wavelength that is able to pass through the sample, including light that is refracted in another direction after passing through the sample. Depending on the embodiment, it may be preferable to minimize the maximum transmission of ultraviolet light, visible light, infrared light, or some combination thereof. In one embodiment of the invention, maximum transmission of light having a wavelength greater than or equal to 200 nm and less than or equal to 900 nm is minimized. In an alternate embodiment, maximum transmission of light having a wavelength of about 200 nm is minimized. In an alternate embodiment, maximum transmission of light having a wavelength of about 900 nm is minimized. Generally speaking, including a light-blocking ink layer 4 will decrease the maximum transmission of light having a wavelength greater than or equal to 200 nm and less than or equal to 900 nm when measured using an integrated sphere spectrophotometer. A light-blocking label may have a maximum transmission of one or more wavelength of light measured using an integrated sphere of less than or equal to 5%, alternatively less than or equal to 2%, or still alternatively less than or equal to 1%.

Light-blocking labels-such as light-blocking labels 100, 200, 300, 400, 500, 600, 700, 800, 900, 1000, 1100—may be printed using printing methods such as, for example, combination screen, digital, flexography, lithography, rotogravure, other suitable printing methods, or some combination thereof. In one such embodiment, the light-blocking label is printed using a rotogravure printer. The light-blocking ink layer 4 may be printed on a side of the of the label substrate 2 that is configured to be proximal to the article (i.e., reverse printed) while one or more ink layer-such as the white ink layer 5, the ink layer 6, and/or the color ink layer 7—may be printed on another surface of the label substrate 2 (i.e., surface printed) or be printed on the second label substrate 12. By printing these inks on different surfaces and/or different label substrates, the drying time for both the light-blocking ink and the one or more ink layers may be reduced, allowing for higher throughput of producing light-blocking labels.

With reference to FIGS. 1 and 2, methods of producing a light-blocking label in accordance with principles of the present invention may involve feeding label substrate 2 into a printing apparatus, surface printing one or more ink layer (e.g., one or more white ink layer 5, one or more ink layer 6, one or more color ink layer 7, etc.) onto a first side of the label substrate 2 feedstock configured to be distal from an article made of PET when affixed thereto and subsequently reverse printing one or more light-blocking ink layer 4 onto a second side of the label substrate 2 feedstock. In a further embodiment, an optional varnish layer 8 may be applied to at least partially cover one or more of the outermost ink layers (e.g., surface printed directly above the ink layer 6 and/or the color ink layer 7, and/or reverse printed directly below the light-blocking ink layer 4). Alternatively, producing a light-blocking label in accordance with principles of the present invention may involve feeding a label substrate 2 into a printing apparatus, reverse printing one or more light-blocking ink layer 4 onto a first side the label substrate 2 configured to be proximal to an article made of PET when attached thereto and subsequently surface printing one or more ink layer (e.g., one or more white ink layer 5, one or more ink layer 6, one or more color ink layer 7, etc.) onto a second side of the label substrate 2. In a further embodiment, an optional varnish layer 8 may be applied to at least partially cover one or more of the outermost ink layers (e.g., the ink layer 6, the color ink layer 7, and/or the light-blocking ink layer 4).

With reference to FIGS. 3-5, the above methods of producing a light-blocking label may further include applying one or more optional ink primer layer 10 to the label substrate 2 before applying the first ink layer to that side. With reference to FIG. 3, before surface printing the white ink layer 5 onto the label substrate 2, an ink primer layer 10 may be surface printed onto a first side of label substrate 2 configured to be distal from the article made of PET when attached thereto. With reference to FIG. 4, before reverse printing the light-blocking ink layer 4 onto the label substrate 2, an ink primer layer 10 may be reverse printed onto a first side of label substrate 2 configured to be proximal to the article made of PET when attached thereto. With reference to FIG. 5, before printing the white ink layer 5 and the light-blocking ink layer 4 onto the label substrate 2, an ink primer layer 10 may be both surface printed and reverse printed onto the label substrate 2. In a further embodiment thereof, the ink primer 10 surface printed between the white ink layer 5 and the label substrate 2 is different from the ink primer layer 10 reverse printed between the light-blocking ink layer 4 and the label substrate 2.

When printing using a rotogravure printer, one or more gravure cylinder may be used to carry an ink and one or more impression roll (one for each gravure cylinder) may be used to apply the ink from the gravure cylinder to the impression roll. Each gravure cylinder has a plurality of cell configurations that can impact the printing process such as, for example, cell angle, cell volume, cell depth, wall thickness, and line screen settings. As used herein, line screen settings are measured in lines per cm (LPC) such that higher LPC values are indicative of a greater density of cells. In one embodiment, the LPC is greater than or equal to 48 LPC and less than or equal to 70 LPC, alternatively greater than or equal to 54 LPC and less than or equal to 60 LPC. In another embodiment, the LPC is 48 LPC, alternatively 54 LPC, still alternatively 60 LPC, or yet further alternatively 70 LPC. Cell angles (i.e., angle 0) can impact the ink release percentage per cell. In one embodiment, the angle 0 of cells in a gravure cylinder may be greater than or equal to 0° and less than or equal to 4°. When printing multiple bumps of ink (e.g., printing multiple bumps of white ink in white ink layer 5), the angle 0 may differ between adjacent bumps. In one such embodiment, the angle 0 differs by less than or equal to ±3°, alternatively less than or equal to ±2°, or alternatively still less than or equal to ±1°.

Cell volume may be affected by one or more parameter including, but not limited to, stylus type, engraving method, cylinder material, cell depth, wall thickness, and line screen. A plurality of cells may be engraved into a gravure cylinder using one or more method known in the art such as, for example, laser etching, chemical etching, mechanical etching, or other suitable etching processes known in the art. Generally speaking, smaller cell volumes result in less ink volume per bump, which in turn results in lower ink drying times allowing the printer to run at faster speeds for a higher throughput. However, higher cell volumes deposit greater volumes of ink per bump, which in turn can, for example, reduce the number of bumps of light-blocking ink used for the light-blocking ink layer 4.

### Example 1

Light-blocking labels (in accordance with principles of the present invention) were prepared, and the labels (and graphics and text provided by the ink) were then tested. In particular, light-blocking labels having a label substrate, a washable, light-blocking ink layer, and an ink layer were tested and compared to similar labels not including the washable, light-blocking ink layer.

### Materials

Materials used in tested labels include the label substrate 2, a washable, light blocking ink layer 4, a white ink layer 5, and a color ink layer 7.

The label substrate 2 was CPET.

The washable light-blocking ink layers 4 tested included one of either a metallic ink or a black ink depending on the sample. These samples were compared to a control not including a washable, light-blocking ink layer 4. When included, these washable, light-blocking inks 4 were positioned below the label substrate 2 (i.e., were configured to be more proximal to the article made of PET when affixed to the article made of PET).

Additionally, at least one ink layer 6—selected from the group consisting of a yellow ink (which may also function as a color ink layer 7) and a white ink (which may also function as a white ink layer 5)—was included and positioned above the label substrate 2. These inks were recycling friendly washable, gravure inks that can be removed from the light-blocking label without staining the recycled PET or wash water during the hot caustic bath sink-float separation step.

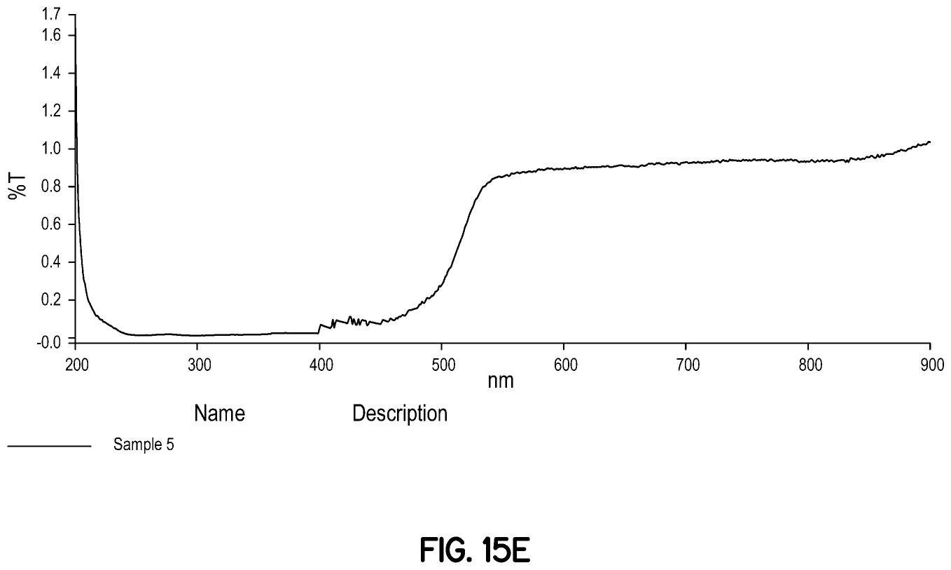

Accordingly, there were six permutations of labels tested that are shown in FIG. 12: (1) No Backing Yellow; (2) No Backing White; (3) Black Backing Yellow; (4) Black Backing White; (5) Metallic Backing Yellow; and (6) Metallic Backing White. Samples not having a washable, light-blocking ink layer 4 are labeled “No Backing”, samples having a metallic washable, light-blocking ink layer 4 are titled “Metallic Backing”, and samples having a black washable, light-blocking ink layer 4 are titled “Black Backing”. With reference to FIG. 12, the yellow/white color of the ink is indicated after the backing (e.g., “Black Backing Yellow” has a black washable, light-blocking ink layer 4 positioned below the label substrate 2 and a yellow ink positioned above the label substrate 2).

### Methods

Where indicated, the testing procedure outlined was performed to substantially conform with the processes outlined by the American Society for Testing and Materials (ASTM). For example, the process used may have a designation of ASTM D1894-14. In this case, the designated test 1894 was either originally adopted or most recently revised in 2014. Additionally, the most recent year the test was reapproved is indicated by subsequently including the year in parenthesis, for example, ASTM D5264-98 (2019).

Transmittance: Test was conducted by measuring the intensity of light between 200-800 nm able to pass through the label and comparing that value to the intensity of the same wavelength of light prior to passing through the label. An Evolution 201 UV-VIS spectrophotometer was used to collect all data.

Opacity: Test was conducted by measuring the luminance (i.e., the Y value in CIELAB color space) of a sample label using the X-Rite eXact Advanced and Scan device implementing the X-Rite method. The X-Rite method entails comparing the measured luminance of a sample label when positioned over a white substrate (e.g., the white portion of a Leneta Form 5C Opacity card) and when positioned over a black substrate (e.g., the black portion of a Leneta Form 5C Opacity card). Opacity measurements are expressed on a scale of 0-100%, where a 100% opacity value indicates that the sample is completely opaque.

L-Value: Test was conducted on labels having white ink using the CIELAB color space to determine the L-values for each using the X-Rite exact Advanced and Scan device implementing the X-Rite method.

APR Ink Bleed Test: Test was conducted with caustic bath, heating plate with magnetic stirring, and spectrophotometer in accordance with guidelines set out by the Association of Plastic Recyclers (APR). The label and PET flakes, which are materials obtained from articles made of PET such as bottles, were stirred together in the caustic bath heated to 85° C. for 15 minutes. After, the caustic bath was allowed to cool to room temperature. Subsequently, the PET flakes were filtrated from the caustic bath and the caustic bath was reserved for observation. The PET flakes were then rinsed with distilled water, dried, then reserved for observation. Testing to assess the PET flakes included transmittance, haze, and clarity of the samples.

Adhesion Tape Test: Test was conducted with 1 inch 600 Adhesive Tape (supplied by 3M) and a 2.2 kg weighted roller. The tape was applied to the sample to evaluate ink adhesion. The tape was rolled two times back and forth with the weighted roller and allowed to dwell on the label for at least 15 seconds. Then, the tape was removed from the label at a moderate speed. Upon removal from sample, the tape and label were inspected for ink/varnish transfer.

Crinkle Test: Test was conducted by hand. Samples were physically compressed (i.e., crinkled) then subsequently visually inspected for defects upon completion of the test.

Sutherland Dry Rubs Test: Test was conducted with a chipboard for 500 cycles using a 4 pound weight and ivory board. Samples were tested using the procedure outlined in ASTM D5264-98 (2019). Samples were inspected for defects upon completion of the test.

Block Test: Test was conducted using a 2 pound block at 110° for 24 hours using cardboard, a PMC Die, an oven, and various weights. The PMC Die was then used to cut samples to a consistent size. Then, the samples were divided into pairs, and each pair was placed with labels facing ink-to-ink on a piece of cardboard. These pairs were then covered with another piece of cardboard and a 2-pound weight was placed on top of each stack. These pairs were then placed in the oven at 110° F. for 5 hours. Then, the samples were allowed to cool and inspected for adhesion between the labels.

Static Coefficient of Friction Test: Test was conducted with a drive apparatus including a sled and a plane. Samples were tested using the procedure outlined in ASTM D1894-14. The drive apparatus was configured to apply a force sufficient to cause the sled to move relative to the plane at a speed of 150±30 mm/min when no samples are analyzed. Then, a first sample was applied to the bottom surface of the sled and a second sample was applied to the top surface of the plant such that the first sample would move along the second sample when the force was applied. The force required to cause the first sample to move relative to the second sample was recorded and used to calculate the coefficient of static friction. Samples were inspected for defects after completion of the test.

Kinetic Coefficient of Friction Test: Test was conducted with a drive apparatus including a sled and a plane. Samples were tested using the procedure outlined in ASTM D1894-14. The drive apparatus is configured to apply a force sufficient to cause the sled to move relative to the plane at a speed of 150±30 mm/min when no samples are analyzed. Then, a first sample is applied to the bottom surface of the sled and a second sample is applied to the top surface of the plant such that the first sample will move along the second sample when the force is applied. The average force measured while the first sample moves relative to the second sample was recorded and used to calculate the coefficient of static friction. Samples were inspected for defects after completion of the test.

### DISCUSSION

With reference to FIG. 12, the transmittance for each sample relative to the tested wavelengths are shown. As can be seen, the transmittance for all samples was nearly zero for all wavelengths less than 400 nm. However, the degree to which transmittance increased afterward depended on the samples. Generally speaking, the transmittance the “No Backing” samples had higher transmittance at wavelengths between 400-800 nm than the “Metallic Backing” samples, which in turn generally had higher transmittance values between 400-800 nm than “Black Backing” samples. Additionally, samples having a white ink had higher transmittance values at lower wavelengths in the 400-800 nm range than similar samples having a yellow ink.

With respect to L-values, the tests were done on the labels having white ink (i.e., No Backing White, Metallic Backing White, and Black Backing White) as shown in Table 1 below:

TABLE 1

| Variable | L-Value | Opacity |
|---|---|---|
| No Backing White | 92.94 | 86.3% |
| Metallic Backing White | 88.08 | 99.2% |
| Black Backing White | 84.78 | 99.8% |

Table 1 compares the L-values and Opacity for each label above.

As can be seen from FIG. 12 and Table 1, there are opposite trends for L-value and opacity of the various washable, light-blocking inks. With respect to L-value, the No Backing sample had a higher L-value than the Metallic Backing sample, which in turn had a higher L-value than the Black Backing sample. With respect to the Opacity, the Black Backing sample had greater opacity than the Metallic Backing sample, which in turn had greater opacity than the No Backing sample.

The other tests listed above were done to determine the properties of the light-blocking labels relevant to recycling. Several samples were created using different graphic layout and application techniques. Labels tested using the methods above matched overall finished design of current product on the market by color and appearance. The light-blocking labels passed all other testing listed above with the sole exception of the Black Backing White/Yellow samples failing the block test. There were no issues with the adhesion tape test, the crinkle test, the APR Ink Bleed Test, the Sutherland dry rub test, the static coefficient of friction test, or the kinetic coefficient of friction test. Moreover, passing the APR Ink Bleed Test indicates that the inks, including the washable, light-blocking ink layer 4, do not substantially affect the recyclability of the article made of PET.

### Example 2

Light-blocking labels (in accordance with principles of the present invention) were prepared, and the labels (and graphics and text provided by the ink) were then tested. In particular, tests were performed to see how multiple layers of the light-blocking ink 4 and/or multiple layers of the white ink layer 5 and/or the color ink layer 7 would impact the L-value for the light-blocking labels.

### Materials

Materials used in tested labels include the label substrate, one or more washable, light blocking ink layer 4, and one or more white ink layer 5.

The label substrate 2 was CPET.

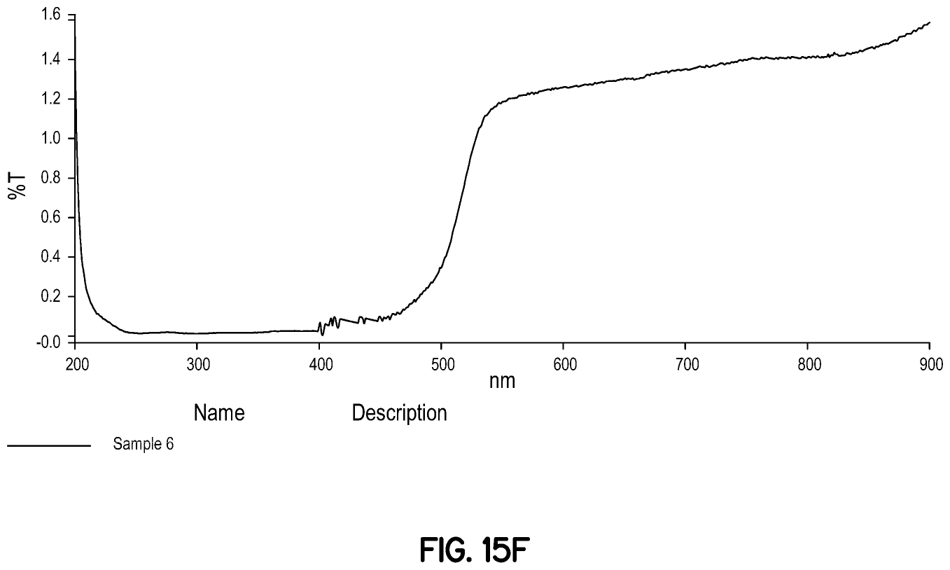

The white ink layer 5 was a washable gravure ink that can be removed from the wrap-around label without staining the recycled PET or wash water during the hot caustic bath sink-float separation step. For purposes of comparison, samples were prepared having one, two and three bumps of white ink within the white ink layer 5 above the label substrate 2. With reference to FIG. 13, this is shown on the X-axis using “Bumps of White”.

The washable light-blocking ink layer 4 tested was the metallic light-blocking ink. The metallic light blocking ink was tested when surface printed onto the label substrate 2 (i.e., between the bottom-most white ink layer 5 and the label substrate) and reverse printed onto the label substrate 2 (i.e., were configured to be more proximal to the article made of PET when affixed to the article made of PET). With reference to FIG. 13, this is shown using boxes with diagonal lines and plain boxes to indicate the difference between “Blocker Ink Direct” (i.e., surface printed onto the label substrate 2) and “Blocker Ink Reverse” (i.e., reverse printed onto the label substrate) respectively.

Accordingly, there were six permutations of labels tested that are shown in FIG. 13. There two samples with each of one bump of white ink, two bumps of white ink, and three bumps of white ink. For each of the configurations of white inks, there is one sample where the metallic ink is surface printed onto the label substrate 2 and another sample where the metallic ink is reverse printed onto the label substrate.

### Methods

L-Value: Test was conducted on labels having white ink using the CIELAB color space to determine the L-values for each using the X-Rite exact Advanced and Scan device implementing the X-RITE method.

### DISCUSSION

With respect to L-values, the tests were done on each label described above as shown in Table 2 below:

TABLE 2

| | Blocker Ink Direct | Blocker Ink Reverse |
|---|---|---|
| 1 Bump White | 68.68 | 76.70 |
| 2 Bumps White | 78.30 | 83.41 |
| 3 Bumps White | 82.36 | 86.62 |

Table 2 compares the L-values for samples having different amounts of white ink layers and different placements of the metallic light-blocking ink layer. Each L-value is shown at the intersection for the two variables.

As can be seen from FIG. 13 and Table 2, there are a few clear trends. First, it is clear that increasing the bumps of white leads to increases in L-value regardless of whether the metallic light-blocking ink is surface printed or reverse printed. Second, there appear to be diminishing returns for including additional bumps of white ink, as the difference between 1 bump and 2 bumps is larger than the difference between 2 bumps and three bumps regardless of whether the metallic light-blocking ink is surface printed or reverse printed. Third, it is clear that reverse printing the metallic light-blocking ink is significant. All “Blocker Ink Reverse” samples, which were reverse printed, have higher L-values than their “Blocker Ink Direct” counterparts, which were surface printed, having an equal amount of white ink bumps. This difference is roughly equal to including an additional bump of white ink on the “Blocker Ink Direct” samples. Accordingly, it may be preferable to reverse print the washable, light-blocking ink layer 4 onto the label substrate 2 (i.e., on the opposite side of the outwardly facing side for the white ink layer 5 and/or the color ink layer 7).

### Example 3

Light-blocking labels (in accordance with principles of the present invention) were prepared, and the labels (and graphics and text provided by the ink) were then tested. In particular, methods for producing light-blocking labels using a gravure printing system having different line screen settings were tested and compared.

### Materials

Materials used in tested labels include the label substrate, a washable, light blocking ink layer 4, a white ink layer 5, and a color ink layer 7. The label substrate was CPET. The washable light-blocking ink layer 4 tested was a metallic washable, light-blocking ink. When included, these washable, light-blocking inks were positioned below the label substrate (i.e., were configured to be more proximal to the article made of PET when affixed to the article made of PET). The white ink layer 5 was a washable, gravure ink that can be removed from the wrap-around label without staining the recycled PET or wash water during the hot caustic bath sink-float separation step. The color ink layer 7, which was surface printed above the white ink layer 5, was a washable, gravure ink that can be removed from the wrap-around label without staining the recycled PET or wash water during the hot caustic bath sink-float separation step.

### Methods

The labels were tested by printing the metallic washable, light-blocking ink layer 4 using different line screen settings for the ink wells. Line screen settings tested include 48 LPC, 54 LPC, 60 LPC, and 70 LPC. Various tests were performed on the light-blocking labels formed using the above line screen settings. These tests included maximum transmission, opacity, L-value, and the tape test.

Transmittance: Test was conducted on labels determine how much light was able to pass through a sample. An Evolution 201 UV-VIS spectrophotometer was used to collect all data.

Opacity: Test was conducted by measuring the luminance (i.e., the Y value in CIELAB color space) of a sample label using the X-Rite eXact Advanced and Scan device implementing the X-Rite method. The X-Rite method entails comparing the measured luminance of a sample label when positioned over a white substrate (e.g., the white portion of a Leneta Form 5C Opacity card) and when positioned over a black substrate (e.g., the black portion of a Leneta Form 5C Opacity card). Opacity measurements are expressed on a scale of 0-100%, where a 100% opacity value indicates that the sample is completely opaque.

L-Value: Test was conducted on labels using the CIELAB color space to determine the L-values for each sample using the X-Rite exact Advanced and Scan device implementing the X-Rite method.

Adhesion Tape Test: Test was conducted with 1 inch 600 Adhesive Tape (supplied by 3M) and a 2.2 kg weighted roller. The tape was applied to the sample to evaluate ink adhesion. The tape was rolled two times back and forth with the weighted roller and allowed to dwell on the label for at least 15 seconds. Then, the tape was removed from the label at a moderate speed. Upon removal from sample, the tape and label were inspected for ink/varnish transfer.

### DISCUSSION

TABLE 3

| Line Screen | | | | |
|---|---|---|---|---|
| (LPC) | Max Transmission | L-Value | Opacity | Tape Test |
| 48 | 1.32% | 93.26 | Pass | Pass |
| 54 | 1.82% | 92.72 | Pass | Pass |
| 60 | 2.54% | 92.52 | Pass | Pass |
| 70 | 3.62% | 99.3 | Pass | Pass |

Table 3 compares max transmission, opacity, L-value, and tape test results for samples having different line screen per cm measurements.

As can be seen from Table 3, increasing line screen values for the metallic, light blocking ink correlated with increasing maximum transmission values. With respect to the L-value of the various samples, there was no significant trend between line screen settings between 48 LPC and 60 LPC. However, there was a significant L-value increase when printing the light-blocking label samples having a line screen setting of 70 LPC. Given the corresponding increase of maximum transmission at higher LPC values, this may be indicative of heavier coat weights of the metallic washable, light-blocking ink layer 4 at higher LPC values. Accordingly, in embodiments where it is important to minimize max transmission and maximize L-value, it may be advantageous to apply multiple layers (i.e., pumps) of the metallic washable, light-blocking ink layer 4.

With respect to opacity and tape testing of the label samples, all samples passed without issues. With respect to opacity, a sample passed if it had a measured opacity greater than or equal to 80%. With respect to tape testing, a sample was deemed to have passed if it did not show visual signs of ink transfer.

### Example 4

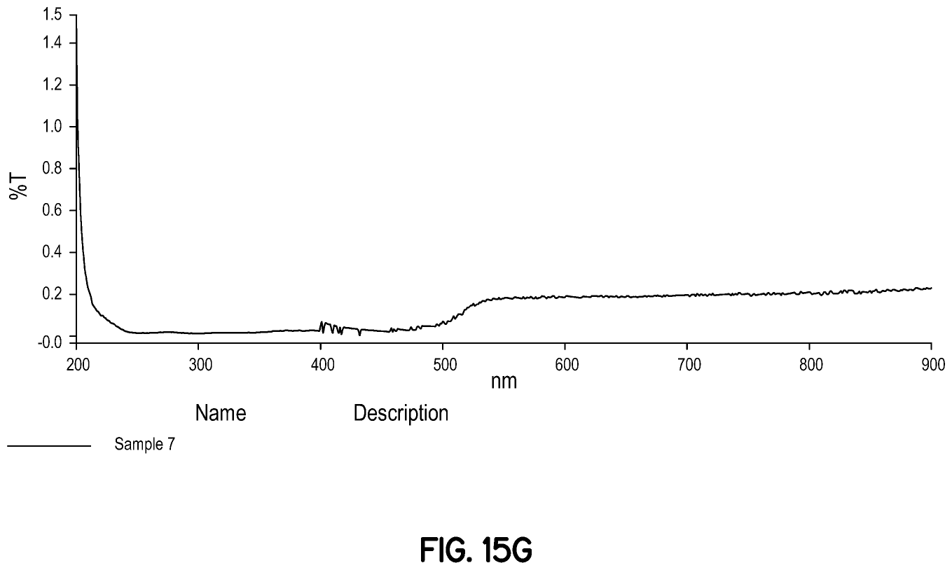

Seven light-blocking label samples (samples 1-7) were prepared in accordance with principles of the present invention and one control sample (sample 8) were prepared, and the label samples (and graphics and text provided by the ink) were then tested. Each label sample was prepared by a sequential surface printing of ink and/or varnish bumps (S1 prints above Substrate, then S2 prints above S1, and so on), followed by sequential reverse printing of ink or varnish bumps (R1 prints below Substrate, then R2 prints below R1, and so on). With reference to FIG. 14, the seven light-blocking label (samples 1-7) had a structure according to an embodiment shown in FIG. 2—including a label substrate 2, a washable, light-blocking ink layer 4, a white ink layer 5, a color ink layer 7, and a varnish layer 8 (directly above the color ink layer 7 but not below the washable, light blocking ink layer 4)—were tested and compared to a control (sample 8). The control had a conventional shrink sleeve label structure wherein the color ink layer 7 was reverse printed onto (i.e., below) the label substrate 2, a white ink layer 5 was reverse printed below the color ink layer 7, a washable, light-blocking ink layer 4 was reverse printed below the white ink layer 5, and an optional varnish layer 8 was surface printed onto (i.e., above) the label substrate 2.

### Materials

Materials used in tested label samples 1-8 include the label substrate 2, a washable, light blocking ink layer 4, a washable, white ink layer 5, a washable, color ink layer 7, and a varnish layer 8. With reference to FIG. 14, the materials used for samples 1-8 and their positions relative to the substrate are shown.

For all tested samples, the label substrate 2 was CPET, specifically the SCLRR 102435 45 μm gauge CPET film supplied by SKC Films.

The washable light-blocking ink layers 4 tested included one of several metallic inks depending on the sample. Samples 1-3 included the INX-1661572 ink (supplied by INX International Ink Co.). Samples 4, 7, and 8 included the Novamet 2351 ink (supplied by Multi-Color Corporation). Samples 5 and 6 included the Novamet 2355 ink (supplied by Multi-Color Corporation). The metallic flake pigment of the Novamet 2355 ink had a greater average particle size than the Novamet 2351 ink.

The white ink layer 5 included 3 bumps of one or more washable white ink depending on the sample. For samples 1-7, the first bump (S1) was applied directly to the label substrate 2, with the second (S2) and third (S3) bumps being applied to the previous white ink bump. For sample 8, the first bump of white ink (R2) was applied to the color ink layer 7, with the second (R3) and third (R4) bumps of white ink being applied to the previous white ink bump. In all embodiments, the white ink used for the first bump was the same as the white ink used for the second bump. Only sample 2 had the same white ink used for all three bumps of white ink, specifically the INX-1671985 ink (supplied by INX International Ink Co.). For samples 1 and 6-8, the white ink used for the first and second bump was the INX-1676985 ink (supplied by INX International Ink Co.) while the white ink for the third bump was the INX-1671091 ink (supplied by INX International Ink Co.). For samples 3-5, the white ink used for the first and second bump was the INX-164308 ink (supplied by INX International Ink Co.) while the white ink for the third bump was the INX-1671091 ink (supplied by INX International Ink Co.).

For all tested samples, the color ink layer 7 included a washable yellow ink, specifically the GENY-0108C ink (supplied by INX International Ink Co.).

For all tested samples, the optional varnish layer 8 was included either directly above the color ink layer 7 (samples 1-7) or directly above the label substrate 2 (sample 8). In all cases the optional varnish layer 8 was the UP 1505 over print varnish (supplied by Hi-Tech Coatings).

### Methods

Where indicated, the testing procedure outlined was performed to substantially conform with the processes outlined by the American Society for Testing and Materials (ASTM). For example, the process used may have a designation of ASTM D1894-14. In this case, the designated test 1894 was either originally adopted or most recently revised in 2014. Additionally, the most recent year the test was reapproved is indicated by subsequently including the year in parenthesis, for example, ASTM D5264-98 (2019).

Transmittance: Test was conducted by measuring the intensity of light between 200-900 nm able to pass through the label and comparing that value to the intensity of the same wavelength of light prior to passing through the label. A Perkin Elmer Lambda 365 UV-Vis with integrated sphere for spectrophotometric analyses was used to collect all data.

Opacity: Test was conducted by measuring the luminance (i.e., the Y value in CIELAB color space) of a sample label using the X-Rite exact Advanced and Scan device implementing the X-Rite method. The X-Rite method entails comparing the measured luminance of a sample label when positioned over a white substrate (e.g., the white portion of a Leneta Form 5C Opacity card) and when positioned over a black substrate (e.g., the black portion of a Leneta Form 5C Opacity card). Opacity measurements are expressed on a scale of 0-100%, where a 100% opacity value indicates that the sample is completely opaque.

L-Value: Test was conducted on label samples using the CIELAB color space to determine the L-values for each using the X-Rite exact Advanced and Scan device implementing the X-RITE method.

APR Ink Bleed Test: Test was conducted with caustic bath, heating plate with magnetic stirring, and spectrophotometer in accordance with guidelines set out by the Association of Plastic Recyclers (APR). The label and PET flakes, which are materials obtained from articles made of PET such as bottles, were stirred together in the caustic bath heated to 85° C. for 15 minutes. After, the caustic bath was allowed to cool to room temperature. Subsequently, the PET flakes were filtrated from the caustic bath and the caustic bath was reserved for observation. The PET flakes were then rinsed with distilled water, dried, then reserved for observation. Testing to assess the PET flakes included transmittance, haze, and clarity of the samples.

Adhesion Tape Test: Test was conducted with 1 inch 600 Adhesive Tape (supplied by 3M) and a 2.2 kg weighted roller. The tape was applied to the sample to evaluate ink adhesion. The tape was rolled two times back and forth with the weighted roller and allowed to dwell on the label for at least 15 seconds. Then, the tape was removed from the label at a moderate speed. Upon removal from sample, the tape and label were inspected for ink/varnish transfer.

Crinkle Test: Test was conducted by hand. Samples were physically compressed (i.e., crinkled) then subsequently visually inspected for defects upon completion of the test.

Sutherland Dry Rubs Test: Test was conducted with a chipboard for 500 cycles using a 4 pound weight and ivory board. Samples were tested using the procedure outlined in ASTM D5264-98 (2019). Samples were inspected for defects upon completion of the test.

Block Test: Test was conducted using a 2 pound block at 110° for 24 hours using cardboard, a PMC Die, an oven, and various weights. The PMC Die was then used to cut samples to a consistent size. Then, the samples were divided into pairs, and each pair was placed with labels facing ink-to-ink on a piece of cardboard. These pairs were then covered with another piece of cardboard and a 2-pound weight was placed on top of each stack. These pairs were then placed in the oven at 110° F. for 5 hours. Then, the samples were allowed to cool and inspected for adhesion between the labels.

Static Coefficient of Friction Test: Test was conducted with a drive apparatus including a sled and a plane. Samples were tested using the procedure outlined in ASTM D1894-14. The drive apparatus was configured to apply a force sufficient to cause the sled to move relative to the plane at a speed of 150±30 mm/min when no samples are analyzed. Then, a first sample was applied to the bottom surface of the sled and a second sample was applied to the top surface of the plant such that the first sample would move along the second sample when the force was applied. The force required to cause the first sample to move relative to the second sample was recorded and used to calculate the coefficient of static friction. Samples were inspected for defects after completion of the test.

Kinetic Coefficient of Friction Test: Test was conducted with a drive apparatus including a sled and a plane. Samples were tested using the procedure outlined in ASTM D1894-14. The drive apparatus is configured to apply a force sufficient to cause the sled to move relative to the plane at a speed of 150±30 mm/min when no samples are analyzed. Then, a first sample is applied to the bottom surface of the sled and a second sample is applied to the top surface of the plant such that the first sample will move along the second sample when the force is applied. The average force measured while the first sample moves relative to the second sample was recorded and used to calculate the coefficient of static friction. Samples were inspected for defects after completion of the test.

### DISCUSSION

With respect to variations in materials used for labels, there are several helpful comparisons that can be made to determine the effect of using different white inks and the same type of metallic, washable, light-blocking ink. With respect to the metallic, light-blocking ink INX-1661572, comparing sample 1 to sample 2 shows the difference in using the INX-1671091 for the third bump of white ink in sample 1 to using the INX-1676985 for all three bumps of white ink in sample 2. With further respect to the metallic light blocking ink INX-1661572, comparing sample 1 to sample 3 demonstrates the difference in using the INX-1676985 white ink for bumps 1 and 2 in sample 1 and using the INX-1643081 ink for sample 3. With respect to the metallic, light-blocking ink Novamet 2351, comparing samples 4 and 7 shows the difference in using the INX-1676985 white ink for bumps 1 and 2 in sample 7 and using the INX-1643081 ink for sample 4. With respect to the metallic, light-blocking ink Novamet 2355, comparing samples 5 and 6 shows the difference in using the INX-1676985 white ink for bumps 1 and 2 in sample 6 and using the INX-1643081 ink for sample 5.

There are also several helpful comparisons that can be made to determine the effects of using different metallic, light-blocking inks. For example, comparing samples 3, 4, and 5 shows the difference in using the washable, light-blocking metallic inks from INX-1661572 for sample 3, Novamet-2351 for sample 4, and Novamet 2355 for sample 5. A similar comparison that shows the difference in using the washable, light-blocking metallic ink can also be seen between using INX-1661572 for sample 1, Novamet-2351 for sample 7, and Novamet 2355 for sample 6.

With respect to the positional relationships between layers in labels made in accordance with principles of the present invention and layers in conventional labels, there are several helpful comparisons that can be made. Generally speaking, sample 8 can be compared to any of samples 1-7 to determine the effects of changing the positional relationships between types of layers. To make comparisons between labels that are identical in terms of materials used, sample 8 can be compared directly to sample 7.

Table 4 below shows the results for each sample with respect to transmittance at 200 nm, transmittance at 900 nm, L-values, opacity, static COF, and kinetic COF.

TABLE 4
Table 4 compares transmittance values at 200 nm (%),
transmittance values at 900 nm (%), L-value, opacity,
static COF, and kinetic COF for samples 1-8.

| | % T | % T | | | Static | Kinetic |
|---|---|---|---|---|---|---|
| Sample | @ 200 nm | @ 900 nm | L-Value | Opacity | COF | COF |
| 1 | 1.502 | 0.33 | 82.57 | Pass | 0.37 | 0.25 |
| 2 | 1.524 | 0.36 | 81.74 | Pass | 0.38 | 0.25 |
| 3 | 1.522 | 0.49 | 80.80 | Pass | 0.40 | 0.25 |
| 4 | 1.422 | 0.16 | 81.75 | Pass | 0.30 | 0.19 |
| 5 | 1.670 | 1.05 | 83.88 | Pass | 0.16 | 0.11 |
| 6 | 1.51 | 1.588 | 84.24 | Pass | 0.17 | 0.11 |
| 7 | 1.498 | 0.24 | 83.52 | Pass | 0.28 | 0.20 |
| 8 | 1.552 | 0.87 | 78.97 | Pass | 0.21 | 0.15 |

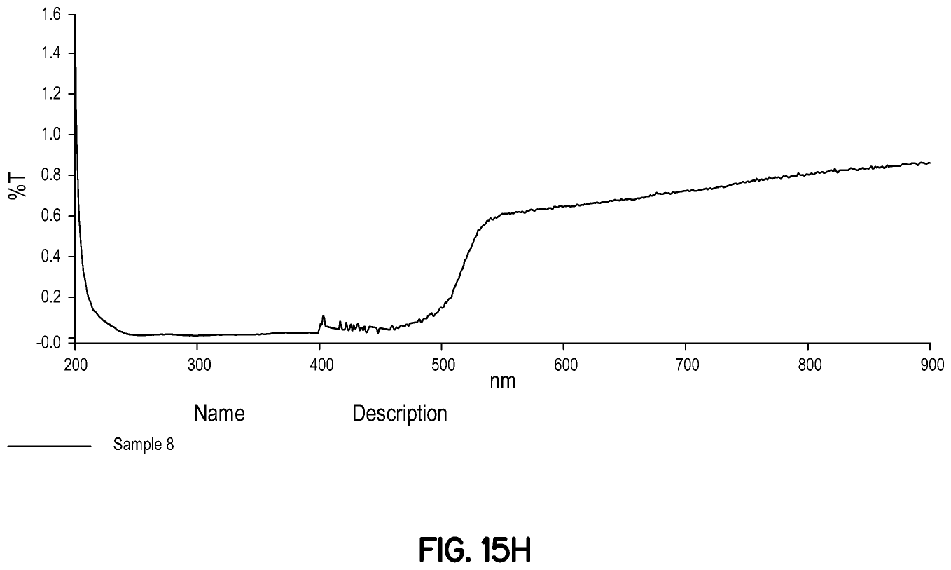

With reference to Table 4 and FIGS. 15A-15H, the transmittance for each sample relative to the tested wavelengths (200-900 nm) are shown. As can be seen, the transmittance for each sample can be broken down into five regions. The first region, starting at 200 nm and ending at approximately 240 nm, shows a rapid and decelerating decay in transmittance from the highest transmittance for each sample at 200 nm (except for sample 6, which has the highest transmittance at 900 nm and a local maximum at 200 nm with approximately 0.1% less transmittance). The second region, starting at approximately 240 nm and ending at 400 nm (where the lamps configured to test transmittance for UV light wavelengths are swapped for lamps configured to test visible light wavelengths), shows a roughly linear section with little increase or decrease in transmittance. In this second section, the transmittance for all tested samples is less than or equal to 0.05%. The third region, starting at 400 nm and ending at approximately 450 nm, shows an increase in noise for measuring transmittance without a substantial increase or decrease in transmittance. The fourth section, beginning at approximately 450 nm and ending at approximately 540 nm, shows an accelerating increase in transmittance measurements. The fifth region, starting at approximately 540 nm and ending at 900 nm, shows a roughly linear increase in transmittance for all samples except for samples 5 and 6, which instead show a roughly linear increase in transmission and also an accelerating increase in transmittance beginning at approximately 830 nm for sample 5 and approximately 770 nm for sample 6.

The maximum transmittance values for samples 1-7 were all less than or equal to 1.670 (sample 5 @ 200 nm), with only one maximum transmission value being in the visible spectrum (sample 6, % T=1.588% @ 900 nm) that was only slightly larger than the local maximum in the UV spectrum (sample 6, % T=1.51% @ 200 nm). The sample having the lowest transmittance values across the board was sample 4. All samples made in accordance with principles of the present invention had maximum UV transmittance values less than or equal to the control sample 8 (% T @ 200 nm=1.552%) except for sample 5 (% T @ 200 nm=1.670%).

With respect to comparing the effects of changing only the white inks used, generally speaking, using different white inks had little effect on the maximum transmittance values in the UV spectrum, with the greatest change in UV maximum transmittance being between samples 5 and 6 (4% T @ 200 nm=0.16%). Further generally speaking, using different white inks also had minimal effects in the maximum transmittance in the visible spectrum with the notable exception of comparing samples 5 and 6. Sample 6 had significantly larger than average increases in transmittance when compared to sample 5 across both the 4th and 5th regions, leading to a gain of transmittance at 900 nm of approximately 0.54%.

With respect to comparing the effects of changing only the washable, metallic, light-blocking inks, generally speaking, using Novamet 2351 (samples 4 and 7) resulted in transmittance values less than or equal to INX-1661572 (samples 3 and 1), which in turn resulted in lower transmittance values less than Novamet 2355 (samples 5 and 6). Notably, the differences in maximum transmittance values were more pronounced in the UV spectrum for samples 4, 3 and 5 (% T @ 200 nm=1.422%<1.522%<1.670%) than for samples 7, 1, and 6 (% T @ 200 nm=1.498%<1.502%<approximately 1.51%) while the differences in the maximum transmittance values were more pronounced in the visual spectrum for samples 7, 1 and 6 (% T @ 900 nm≅0.24%<0.33%<1.588%) than for samples 4, 3 and 5 (% T @ 900 nm≅0.16%<0.49%<1.05%). With respect to comparing the reverse printed metallic, light-blocking ink layer 4 (sample 7) and the control sample with a conventional print order (sample 8), both samples had maximum transmittance values at 200 nm. Notably, samples printed in accordance with the present invention showed an improvement in a lower max transmittance (1.498% for sample 7; 1.552% for sample 8). This reduction in transmittance was more pronounced at 900 nm (approximately 0.24 for sample 7; approximately 0.87 for sample 8).

With respect to L-values as shown in Table 4, there are clear trends when varying the white inks and the metal inks. When comparing samples differing only the white inks used, using the INX-1676985 ink instead of INX-1643081 for surface bumps S1 and S2 led to increased L-value as shown when comparing sample 1 to sample 3 (ΔL=1.77), sample 7 to sample 4 (ΔL=1.77), and sample 6 to sample 5 (ΔL=0.86). When comparing samples differing only the metallic inks used, samples using INX-1661572 ink (samples 3 and 1) resulted in a lower L value than equivalent samples using Novamet 2351 (samples 4 and 7 respectively), which in turn had lower L-values than equivalent samples using Novamet 2355 (samples 5 and 6 respectively). Additionally, there were considerable improvements in L value when comparing sample 7 to sample 8, indicating that samples prepared according to principles of the present invention (sample 7=83.52) outperformed the control sample (sample 8=79.97) having equivalent materials that was prepared using a conventional layer ordering.

With respect to opacity, a sample was considered to have passed if the measured opacity was greater than 80%.

With respect to static COF and kinetic COF, the white inks used for bumps S1 and S2 had minimal impact on either coefficient of friction measurement as shown by comparing samples 1 and 3, samples 7 and 4, and samples 6 and 5. However, the metallic, washable, light-blocking ink chosen led to a noticeable trend wherein using INX-1661572 ink (samples 3 and 1) resulted in a higher kinetic and static COF than using Novamet 2351 (samples 4 and 7 respectively), which in turn resulted in a higher kinetic and static COF than using Novamet 2355 (samples 5 and 6 respectively). One possible reason that the metallic inks used led to a larger difference in the coefficient of friction than the white inks is that the metallic inks were one of the two outermost layers (R1) while the white inks tested were not (S1 and S2). It should be noted that all samples had acceptable static COF and kinetic COF values.

The other tests listed above were done to determine the properties of the light-blocking labels relevant to recycling. Several samples were created using different graphic layout and application techniques. Labels tested using the methods above matched overall finished design of current product on the market by color and appearance. Samples 1-8 had no issues with the adhesion tape test, the crinkle test, the APR Ink Bleed Test, the Sutherland dry rub test, or the block test. Moreover, passing the APR Ink Bleed Test indicates that the inks, including the metallic inks used for the washable, light-blocking ink layer 4, do not substantially affect the recyclability of the article made of PET.

While the present invention has been disclosed by reference to the details of preferred embodiments of the invention, it is to be understood that the disclosure is intended as an illustrative rather than in a limiting sense, as it is contemplated that variations and modifications will readily occur to those skilled in the art, within the spirit of the invention and the scope of the appended claims. Notwithstanding the above, certain variations and modifications, while producing less than optimal results, may still produce satisfactory results. All such variations and modifications are intended to be within the scope of the present invention as defined by the claims appended hereto.

What is claimed is:

1. A light-blocking label, comprising:
a label substrate having a first side and a second side, wherein the first side is configured to be proximate to an article when attached thereto, and wherein the second side is configured to be distal from the article when attached thereto; and
a light-blocking layer positioned below the label substrate, wherein the light-blocking layer comprises a plurality of metallic flake pigment particles.

2. The light-blocking label of claim 1, wherein the plurality of metallic flake pigment particles comprises a metal selected from the list consisting of a silver flake pigment, an aluminum flake pigment, a platinum flake pigment, a palladium flake pigment, a stainless steel flake pigment, a galvanized steel flake pigment, an alloy flake pigment including one or more metal previously listed, or a combination thereof.

3. The light-blocking label of claim 1, wherein the light-blocking layer comprises a magnetizable material.

4. The light-blocking label of claim 1, wherein the plurality of metallic flake pigment particles has an average particle size greater than or equal to 4 microns and less than or equal to 15 microns.

5. The light-blocking label of claim 4, wherein the average particle size is approximately 6 microns.

6. The light-blocking label of claim 4, wherein the average particle size is approximately 11 microns.

7. The light-blocking label of claim 1, further comprising an ink layer positioned above the label substrate.

8. The light-blocking label of claim 7, further comprising a varnish layer positioned above the ink layer.

9. The light-blocking label of claim 7, further comprising a white ink layer positioned below the ink layer and above the light-blocking layer.

10. The light-blocking label of claim 9, further comprising a second label substrate above the ink layer.

11. The light-blocking label of claim 1, wherein the light-blocking label has an L-value greater than or equal to 80.

12. The light-blocking label of claim 1, wherein the light-blocking label has an opacity greater than or equal to 98%.

13. The light-blocking label of claim 12, an L-value greater than or equal to 88.

14. The light-blocking label of claim 1, wherein the label substrate comprises CPET.

15. The light-blocking label of claim 1, wherein the light-blocking label has a higher L-value than an otherwise identical label therein the light blocking layer is positioned above the label substrate.

16. The light-blocking label of claim 1, wherein the light-blocking layer is configured to be removable from the label substrate in a recycling step selected from the list consisting of a magnetic separation step, a wash step, and a caustic bath step.

17. A method of manufacturing a light-blocking label, comprising:
feeding a label substrate into a printing apparatus, wherein the label substrate has a first side and a second side, wherein the first side is configured to be proximate to an article when attached thereto, and wherein the second side is configured to be distal from the article when attached thereto;
reverse printing a light-blocking layer onto the first side, wherein the light-blocking layer comprises a plurality of metallic flake pigment particles.

18. The method of claim 17, wherein reverse printing comprises gravure printing using a line screen setting having a lines per cm (LPC) greater than or equal to 48 and less than or equal to 70.

19. The method of claim 17, further comprising surface printing at least one layer selected from the list consisting of a white ink layer, an ink layer, and a varnish layer.

20. The method of claim 17, further comprising:
surface printing multiple bumps of a white ink onto the second side of the label substrate to form a white ink layer; and
surface printing an ink layer above the white ink layer.
